(19) United States
(12) Patent Application Publication
(10) Pub. No.: US 2009/0187665 A1
(43) Pub. Date: Jul. 23, 2009

(54) DATA COMMUNICATION SYSTEM SUITED FOR TRANSMITTING AND RECEIVING DATA AMONG A PLURALITY OF DATA COMMUNICATION APPARATUSES CONNECTED TO A NETWORK, DATA TRANSMISSION APPARATUS CONSTITUTING SUCH SYSTEM, AND TRANSMISSION DESTINATION UPDATE METHOD AND TRANSMISSION DESTINATION UPDATE PROGRAM EXECUTED BY SUCH DATA TRANSMISSION APPARATUS

(75) Inventors: Kaitaku Ozawa, Itami-shi (JP); Toshiya Shozaki, Osaka-shi (JP); Junichi Hase, Osaka-shi (JP); Ryuichi Kitaoka, Uji-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/341,662

(22) Filed: Dec. 22, 2008

(30) Foreign Application Priority Data
Jan. 21, 2008 (JP) 2008-011009

(51) Int. Cl. G06F 15/16

(52) U.S. Cl. 709/228

(57) ABSTRACT

In order to allow the communication method for receiving data to be set at the side receiving the data, among a plurality of data communication apparatuses, a data transmission apparatus includes a destination designation portion for accepting designation of user identification information, a data accepting portion for accepting data, a data transmission portion for transmitting the data based on a communication method and destination information stored in association with the user identification information, a comparing portion for comparing the communication method stored in association with user identification information included in reply data with a communication method by which the reply data was received when the reply data for the transmitted data is received, and an update portion for updating the communication method and the destination information stored in association with the user identification information included in the reply data with the communication method by which the reply data was received and with the destination information included in the reply data based on the result of a comparison.

This application is based on Japanese Patent Application No. 2008-011009 filed with Japan Patent Office on Jan. 21, 2008, the entire content of which is hereby incorporated by reference.

### BACKGROUND OF THE INVENTION

1. Field of the Invention

The present invention relates to a data communication system, a data transmission apparatus, a transmission destination update method, and a transmission destination update program, and more specifically to a data communication system suited for transmitting and receiving data among a plurality of data communication apparatuses connected to a network, a data transmission apparatus constituting such system, and a transmission destination update method and a transmission destination update program executed by such data transmission apparatus.

2. Description of the Related Art

Conventionally, when data is to be transmitted, the sender is required to set a variety of information related to the receiver and the destination of the transmission. For instance, when a document is to be transmitted by facsimile, the sender is required to set the facsimile number of the receiver, and when an image scanned by a copying machine is to be transmitted by electronic mail, the sender is required to set the electronic mail address of the receiver. Moreover, with regard to an FTP (File Transfer Protocol) transmission function and an SMB (Server Message Block) transmission function provided in recent copying machines, the setting of information (FTP server address, name of personal computer, etc.) of the receiver by the sender is required. Although the information of the receiver need not be set every time upon the actual transmission if the information of the receiver is registered in advance, the information of the receiver is required upon the advance registration nonetheless.

Since the sender basically selects one of a facsimile transmission, an electronic mail transmission, an FTP transmission, an SMB transmission, and the like as the method of communication at his convenience, the transmitted data is not in a form that takes the convenience of the receiver into consideration. After receiving the data, the receiver is sometimes forced to process the data later on in some way in order to make the data easier to utilize, and at other times, the receiver may not even be able to perform such processing and thus feel inconvenienced. In order to resolve such inconvenience, the sender must confirm the communication method desired by the receiver before the transmission. Thus, it is desirable that the receiver is able to select the communication method.

On the other hand, among Internet facsimile apparatuses capable of transmitting and receiving electronic mail, an Internet facsimile apparatus that accepts remote setting by electronic mail to set the apparatus is described in Japanese Patent Laying-Open No. 2003-189041.

In a conventional Internet facsimile apparatus, however, a user is required to transmit electronic mail to the Internet facsimile apparatus in order to change the setting. In other words, the user must create an electronic mail for the sole purpose of changing the setting of the Internet facsimile apparatus, and further, the user must know the electronic mail address assigned to the Internet facsimile apparatus. Thus, there was a problem that the work of changing the setting was imposed on the user, which complicated the procedure.

### SUMMARY OF THE INVENTION

The present invention is made to solve the above-described problem, and an object of the present invention is to provide a data communication system that allows the communication method for receiving data to be set at the side receiving the data.

Another object of the present invention is to provide a data transmission apparatus that allows the communication method for receiving data to be set at the side receiving the data.

A still another object of the present invention is to provide a transmission destination update method that allows the communication method for receiving data to be set at the side receiving the data.

A still further object of the present invention is to provide a transmission destination update program that allows the communication method for receiving data to be set at the side receiving the data.

To achieve the above-described objects, according to one aspect of the present invention, a data communication system is provided in which a plurality of data communication apparatuses are connected in a manner enabling communication, each of the plurality of data communication apparatuses including a communication portion capable of communicating in multiple types of communication methods and a user storage portion for associating and storing user identification information of a user, a communication method, and destination information for each user, and among the plurality of data communication apparatuses, a data transmission apparatus includes a destination designation portion for accepting designation of user identification information stored in the user storage portion, a data accepting portion for accepting data, a data transmission portion for controlling the communication portion to transmit the accepted data based on a communication method and destination information stored in association with the accepted user identification information, a comparing portion for comparing the communication method stored in association with user identification information included in reply data with a communication method by which the communication portion receives the reply data when the communication portion receives the reply data for the transmitted data, and an update portion for updating the communication method and the destination information stored in association with the user identification information included in the reply data with the communication method by which the communication portion received the reply data and with the destination information included in the reply data if the communication method stored in association with the user identification information included in the reply data and the communication method by which the communication portion received the reply data do not match as a result of a comparison by the comparing portion.

According to another aspect of the present invention, a data communication system is provided in which a plurality of data communication apparatuses are connected in a manner enabling communication, each of the plurality of data communication apparatuses including a communication portion capable of communicating in multiple types of communication methods, and among the plurality of data communication apparatuses, a data transmission apparatus includes a destination designation portion for accepting destination information and a communication method of communicating data for a user at transmission destination, a data accepting portion for accepting data, a first data transmission portion for controlling the communication portion to transmit the accepted data and a job ID for identifying a job of transmitting the data, based on the communication method and the destination information accepted, a transmission history storage portion for storing transmission history that includes destination information and a communication method of communicating the data transmitted by the first data transmission portion, user identification information for identifying the user at the transmission destination, and the job ID, a second data transmission portion for transmitting data based on the communication method and the destination information included in the transmission history when one of the transmission history is designated, a comparing portion for comparing the communication method included in the transmission history including the job ID and the user identification information included in reply data with a communication method by which the communication portion receives the reply data when the communication portion receives the reply data for the transmitted data, and an update portion for updating the communication method and the destination information included in the transmission history including the job ID and the user identification information included in the reply data with the communication method by which the communication portion received the reply data and with the destination information included in the reply data if the communication method included in the transmission history including the job ID and the user identification information included in the reply data and the communication method by which the communication portion received the reply data do not match as a result of a comparison by the comparing portion.

According to a still another aspect of the present invention, a data transmission apparatus includes a communication portion capable of communicating in multiple types of communication methods, a user storage portion for associating and storing user identification information of a user, a communication method, and destination information for each user, a destination designation portion for accepting designation of user identification information stored in the user storage portion, a data accepting portion for accepting data, a data transmission portion for controlling the communication portion to transmit the accepted data based on a communication method and destination information stored in association with the accepted user identification information, a comparing portion for comparing the communication method stored in association with user identification information included in reply data with a communication method by which the communication portion receives the reply data when the communication portion receives the reply data for the data transmitted, and an update portion for updating the communication method and the destination information stored in association with the user identification information included in the reply data with the communication method by which the communication portion received the reply data and with the destination information included in the reply data if the communication method stored in association with the user identification information included in the reply data and the communication method by which the communication portion received the reply data do not match as a result of a comparison by the comparing portion.

According to a further aspect of the present invention, a data transmission apparatus includes a communication portion capable of communicating in multiple types of communication methods, a destination designation portion for accepting destination information and a communication method of communicating data for a user at transmission destination, a data accepting portion for accepting data, a first data transmission portion for controlling the communication portion to transmit the data accepted and a job ID for identifying a job of transmitting the data, based on the communication method and the destination information accepted, a transmission history storage portion for storing transmission history that includes destination information and a communication method of communicating data transmitted by the first data transmission portion, user identification information for identifying the user at the transmission destination, and the job ID, a second data transmission portion for transmitting data based on the communication method and the destination information included in the transmission history when one of the transmission history is designated, a comparing portion for comparing the communication method included in the transmission history including the job ID and the user identification information included in reply data with a communication method by which the communication portion receives the reply data when the communication portion receives the reply data for the data transmitted, and an update portion for updating the communication method and the destination information included in the transmission history including the job ID and the user identification information included in the reply data with the communication method by which the communication portion received the reply data and with the destination information included in the reply data if the communication method included in the transmission history including the job ID and the user identification information included in the reply data and the communication method by which the communication portion received the reply data do not match as a result of a comparison by the comparing portion.

According to a still further aspect of the present invention, a transmission destination update method executed by a data transmission apparatus including a communication portion capable of communicating in multiple types of communication methods and a user storage portion for associating and storing user identification information of a user, a communication method, and destination information for each user, includes the steps of accepting designation of user identification information stored in the user storage portion, accepting data, controlling the communication portion to transmit the accepted data, based on a communication method and destination information stored in association with the accepted user identification information, comparing the communication method stored in association with user identification information included in reply data with a communication method by which the communication portion receives the reply data when the communication portion receives the reply data for the data transmitted, and updating the communication method and the destination information stored in association with the user identification information included in the reply data with the communication method by which the communication portion received the reply data and with the destination information included in the reply data if the communication method stored in association with the user identification information included in the reply data and the communication method by which the communication portion received the reply data do not match as a result of the comparison.

According to a still further aspect of the present invention, a transmission destination update method executed by a data transmission apparatus including a communication portion capable of communicating in multiple types of communication methods includes the steps of accepting destination information and a communication method of communicating data for a user at transmission destination, accepting data, controlling the communication portion to transmit the accepted data and a job ID for identifying a job of transmitting the data, based on the communication method and the destination information accepted, storing transmission history that includes destination information and a communication method of the data transmitted, user identification information for identifying the user at the transmission destination, and the job ID, transmitting data based on the communication method and the destination information included in the transmission history when one of the transmission history is designated, comparing the communication method included in the transmission history including the job ID and the user identification information included in reply data with a communication method by which the communication portion receives the reply data when the communication portion receives the reply data for the transmitted data, and updating the communication method and the destination information included in the transmission history including the job ID and the user identification information included in the reply data with the communication method by which the communication portion received the reply data and with the destination information included in the reply data if the communication method included in the transmission history including the job ID and the user identification information included in the reply data and the communication method by which the communication portion received the reply data do not match as a result of the comparison.

According to a still further aspect of the present invention, a transmission destination update program, executed by a computer controlling a data transmission apparatus including a communication portion capable of communicating in multiple types of communication methods and a user storage portion for associating and storing user identification information of a user, a communication method, and destination information for each user, causes the computer to execute the steps of accepting designation of user identification information stored in the user storage portion, accepting data, controlling the communication portion to transmit the accepted data based on a communication method and destination information stored in association with the accepted user identification information, comparing the communication method stored in association with user identification information included in reply data with a communication method by which the communication portion receives the reply data when the communication portion receives the reply data for the data transmitted, and updating the communication method and the destination information stored in association with the user identification information included in the reply data with the communication method by which the communication portion received the reply data and with the destination information included in the reply data if the communication method stored in association with the user identification information included in the reply data and the communication method by which the communication portion received the reply data do not match as a result of the comparison.

According to a still further aspect of the present invention, a transmission destination update program executed by a computer controlling a data transmission apparatus including a communication portion capable of communicating in multiple types of communication methods causes the computer to execute the steps of accepting destination information and a communication method of communicating data for a user at transmission destination, accepting data, controlling the communication portion to transmit the accepted data and a job ID for identifying a job of transmitting the data based on the communication method and the destination information accepted, storing transmission history that includes destination information and a communication method of the data transmitted, user identification information for identifying the user at the transmission destination, and the job ID, transmitting data based on the communication method and the destination information included in the transmission history when one of the transmission history is designated, comparing the communication method included in the transmission history including the job ID and the user identification information included in reply data with a communication method by which the communication portion receives the reply data when the communication portion receives the reply data for the data transmitted, and updating the communication method and the destination information included in the transmission history including the job ID and the user identification information included in the reply data with the communication method by which the communication portion received the reply data and with the destination information included in the reply data if the communication method included in the transmission history including the job ID and the user identification information included in the reply data and the communication method by which the communication portion received the reply data do not match as a result of the comparison.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall schematic diagram of a data communication system according to a first embodiment of the present invention.

FIG. 2 is a block diagram showing an example of a hardware arrangement of an MFP (Multi Function Peripheral) 100 according to the first embodiment of the present invention.

FIG. 3 is a functional block diagram showing, along with information stored in a HDD (Hard Disk Drive), an example of a function of a CPU (Central Processing Unit) provided in an MFP that functions as a data transmission apparatus.

FIG. 4 is a diagram showing an example of a job setting window.

FIG. 5 is a diagram showing an example of a user table.

FIG. 6 is a diagram showing an example of transmission history information.

FIG. 7 is a functional block diagram showing, along with information stored in a HDD, an example of a function of a CPU provided in an MFP that functions as a data reception apparatus.

FIG. 8 is a diagram showing an example of an apparatus table.

FIG. 9 is a diagram showing an example of reception history information.

FIG. 10 is a diagram showing an example of reception history information stored in a PC (Personal Computer).

FIG. 11 is a flow chart showing an example of the flow of a main process.

FIG. 12 is a flow chart showing an example of the flow of a data transmission process.

FIG. 13 is a flow chart showing an example of the flow of a data reply process.

FIG. 14 is a flow chart showing an example of the flow of a user table update process.

FIG. 15 is a diagram showing an example of the user table after an update.

FIG. 16 is a functional block diagram showing, along with information stored in a HDD, an example of a function of a CPU provided in an MFP that functions as a data transmission apparatus according to a second embodiment of the present invention.

FIG. 17 is another diagram showing an example of transmission history information.

FIG. 18 is a flow chart showing an example of the flow of a main process according to the second embodiment.

FIG. 19 is a flow chart showing an example of the flow of a same destination transmission process.

FIG. 20 is a flow chart showing an example of the flow of a transmission history update process.

### DESCRIPTION OF THE PREFERRED EMBODIMENTS

The embodiments of the present invention will be described below with reference to the drawings. In the following description, the same or corresponding parts are denoted by the same reference characters. Their names and function are also the same. Thus, the detailed description thereof will not be repeated.

FIG. 1 is an overall schematic diagram of a data communication system according to the first embodiment of the present invention. With reference to FIG. 1, a data communication system 1 includes multi function peripherals (referred to as “MFP” below) 100, 100A, 100B, and 100C, personal computers (referred to as “PC” below) 200 and 200A, and an electronic mail server 300, each connected to a network 2. PC 200, PC 200A, and electronic mail server 300 are common computers. The arrangements and the functions thereof are well known so that the description will not be repeated here. The arrangement and the function of MFPs 100, 100A, 100B, and 100C are the same so that MFP 100 will be described here as an example unless otherwise noted.

MFP (Multi Function Peripheral) 100 includes a scanner for scanning a sheet of original manuscript, an image forming portion for forming an image on recording media such as a sheet of paper based on image data, and a facsimile, and has an image scanning function, a copying function, and a facsimile transmission and reception function. Moreover, although MFP 100 is described as an example in the present embodiment, MFP 100 may be replaced by an apparatus having the function to transmit and receive data using multiple types of communication methods, for instance, a scanner, a printer, a facsimile, a personal computer, and the like.

Network 2 is a local area network (LAN) and is connected to an Internet 3 via a gateway. Network 2 can be either wired or wireless. In addition, network 2 is not limited to a LAN and can be the Internet, a wide area network (WAN), a network using general public lines, and so on.

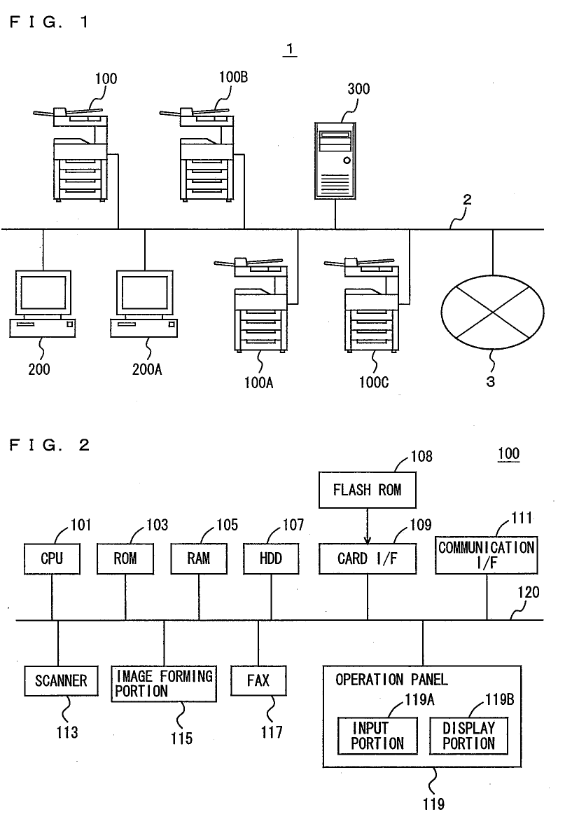

FIG. 2 is a block diagram showing an example of the hardware arrangement of MFP 100 according to the first embodiment of the present invention. With reference to FIG. 2, MFP 100 includes, respectively connected to a bus 120, a central processing unit (CPU) 101, a ROM (Read Only Memory) 103 that stores a program or the like to be executed by CPU 101, a RAM (Random Access Memory) 105 for loading a program to be executed and for storing data during execution of the program, a hard disk drive (HDD) 107 for storing data in a nonvolatile manner, a card interface (I/F) 109 to which a flash ROM 108 is attached, a communication I/F 111 for connecting MFP 100 to network 2, a scanner 113, an image forming portion 115, a facsimile (FAX) 117, and an operation panel 119 providing an interface with a user.

CPU 101 is capable of loading into RAM 105 and executing a program stored in flash ROM 108 attached to card I/F 109. Using flash ROM 108, it becomes possible to rewrite the program or to write a program additionally. Thus, PC 200, PC 200A, or electronic mail server 300 connected to a network 2 may rewrite a data processing program stored in flash ROM 108 attached to MFP 100 or may add and write a new data processing program. Moreover, MFP 100 may download a program from another computer connected to Internet 3 and store that program into flash ROM 108. Furthermore, CPU 101 may load into RAM 105 and execute the program saved in HDD 107.

Further, storage media that stores the program is not limited to flash ROM 108 and may also be the media that records a program in a fixed manner, such as a flexible disk, a cassette tape, an optical disk [MO (Magnetic Optical Disc)/MD (Mini Disc)/DVD (Digital Versatile Disc)], an IC card (including a memory card), an optical card, and a semiconductor memory such as a masked ROM, an EPROM (Erasable Programmable Read-Only Memory), an EEPROM (Electrically Erasable/Programmable Read Only Memory), and the like.

The program referred to here includes not only a program directly executable by CPU 101, but also a program in a source program format, a compressed program, an encrypted program, and the like.

Scanner 113 includes a photoelectric transducer such as a CCD (Charge Coupled Device) and the like, and optically reads a sheet of original manuscript and outputs electronic data that is image data. Image forming portion 115 is a laser printer, an ink jet printer, or the like, and makes the image data visible on recording media such as a sheet of paper. FAX 117 transmits and receives the image data according to the facsimile standard via a public telephone line.

Operation panel 119 includes an input portion 119A and a display portion 119B. Input portion 119A is an input device such as a touch panel, a keyboard, or a mouse for accepting an input of operation by a user of MFP 100. Display portion 119B is a liquid crystal display or an organic EL (Electro-Luminescence) display panel. When using a touch panel formed of a transparent member for input portion 119A, the touch panel is provided overlapping display portion 119B so that an instruction of a button displayed on display portion 119B can be detected. Thus, input of a variety of operations becomes possible.

Communication I/F 111 is a communication interface for connecting MFP 100 to network 2. Thus, it becomes possible for MFP 100 to communicate with other MFPs 100A, 100B, and 100C, PCs 200 and 200A, and electronic mail server 300. Although MFP 100 is connected to other MFPs 100A, 100B, and 100C, PCs 200 and 200A, and electronic mail server 300 via network 2, it can also be connected directly using a serial interface or a parallel interface. In such a case, communication I/F 111 uses an interface that corresponds to the form of connection between MFP 100 and each of other MFPs 100A, 100B, and 100C, PCs 200 and 200A, and electronic mail server 300.

The input of data into MFP 100 includes the following cases: (1) when scanner 113 scans a sheet of original manuscript and the image data is inputted; (2) when data is received from other MFPs 100A, 100B, 100C, PCs 200, 200A, or electronic mail server 300 connected to network 2 via communication I/F 111; (3) when data stored in flash ROM 108 is read via card I/F 109; and (4) when facsimile data is received at FAX 117. The data inputted into MFP 100 is given a file name and is temporarily stored in a prescribed area of HDD 107.

The output of data from MFP 100 includes the following cases: when the data stored in HDD 107 is (1) made visible on recording media such as a sheet of paper by image forming portion 115, (2) transmitted to PCs 200, 200A, other MFPs 100A, 100B, 100C, or electronic mail server 300 connected to network 2 via communication I/F 111, (3) stored in flash ROM 108, (4) outputted as facsimile data by FAX 117, and (5) displayed on display portion 119B.

When data is transmitted via communication I/F 111, the data is transmitted using one of the communication methods of i-FAX where the data is transmitted according to the communication protocol of the Internet facsimile standard, electronic mail where the data is transmitted according to the protocol of transmitting electronic mail, FTP where the data is transmitted according to the communication protocol of FTP, and SMB where the data is transmitted according to the communication protocol of SMB. Thus, adding to these communication methods the communication method of FAX where the data is transmitted according to the communication protocol of the facsimile standard by FAX 117, MFP 100 transmits data using one of the communication methods of facsimile, i-FAX, electronic mail, FTP, and SMB. In other words, MFP 100 is capable of transmitting data using one of a plurality of communication methods.

MFPs 100, 100A, 100B, 100C, and PCs 200, 200A according to the present embodiment are data communication apparatuses capable of transmitting data to and receiving data from one another. Here, the instance where MFP 100 transmits data to MFP 100A will be described as an example. In this case, MFP 100 transmitting the data functions as a data transmission apparatus and MFP 100A receiving the data functions as a data reception apparatus.

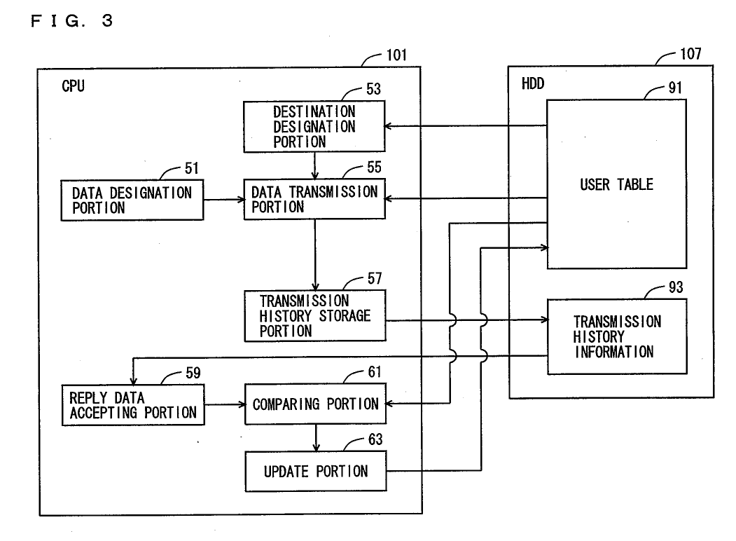

FIG. 3 is a functional block diagram showing, along with information stored in a HDD, an example of a function of a CPU provided in an MFP that functions as a data transmission apparatus. With reference to FIG. 3, CPU 101 provided in MFP 100 that functions as the data transmission apparatus includes a data designation portion 51 for accepting designation of data to be transmitted, a destination designation portion 53 for accepting designation of a destination to which the data is to be transmitted, a data transmission portion 55 for transmitting the data, a transmission history storage portion 57 for storing history information indicating that the data has been transmitted, a reply data accepting portion 59 for receiving reply data that is transmitted back in reply according to the data transmitted, a comparing portion 61, and an update portion 63.

Data designation portion 51 accepts designation of the data to be the object of transmission. The data to be the object of transmission includes image data outputted by scanner 113 having scanned a sheet of original manuscript, and data stored in flash ROM 108 or HDD 107. The data stored in HDD 107 includes data received by communication I/F 111 from another computer and facsimile data received by FAX 117. Data designation portion 51 displays a job setting window on display portion 119B, and accepts the designation of the data when a user, according to the job setting window, inputs into input portion 119A an operation designating the data to be the object of transmission. The job setting window will be described later. Thereafter, the designated data is obtained and the obtained data is outputted to data transmission portion 55.

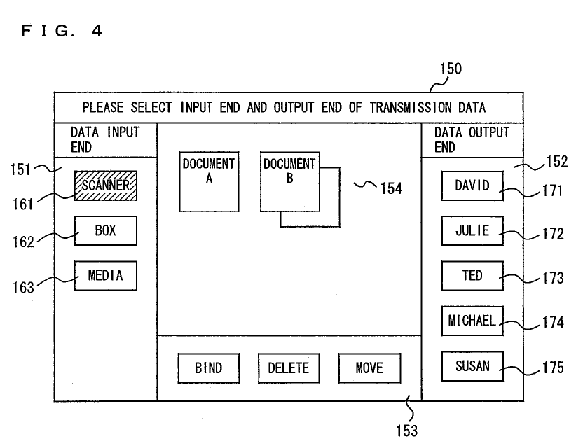

FIG. 4 is a diagram showing an example of the job setting window. With reference to FIG. 4, a job setting window 150 includes an area 151 for accepting a selection instruction from the data input end, an area 153 for instructing edition of the designated data, an area 154 for accepting designation of data to be transmitted, and an area 152 for accepting an instruction of selection of an output end of the data. Area 151 includes a button 161 for instructing input of data from scanner 113, a button 162 for instructing reading of data from a prescribed area (BOX) of HDD 107, and a button 163 for instructing reading of data from storage media such as flash ROM 108. When button 161 is instructed, scanner 113 is activated and a thumbnail, which is a size-reduced image of data to be outputted by scanner 113, is displayed in area 154. When button 162 is instructed, a thumbnail of data stored in an area of HDD 107 corresponding to that button is displayed in area 154. When button 163 is instructed, a thumbnail of data read from flash ROM 108 is displayed in area 154.

By instructing on the thumbnail displayed in area 154, the data corresponding to the instructed thumbnail is designated as the object of transmission. In addition, when the button displayed in area 153 is instructed, such processes as a bind process of putting together a plurality of data, a deletion process of deleting the data from the object of selection, and a move process for changing the order are executed with the data designated in area 154.

Area 152 is an area for setting an instruction of selection of an output end of the data. Area 152 includes buttons 171 to 175 for designating “people” as the output end.

Going back to FIG. 3, destination designation portion 53 accepts the designation of a destination to which the data is to be transmitted. A destination is a user who becomes the destination of transmission. Destination designation portion 53 reads a user table 91 stored in HDD 107, and displays user identification information for identifying a user on each of buttons 171 to 175 included in area 152 of job setting window 150 shown in FIG. 4. In job setting window 150 shown in FIG. 4, when a user inputs an operation for instructing on one of buttons 171 to 175 included in job setting window 150 into input portion 119A, destination designation portion 53 accepts the designation of the user of the user identification information corresponding to the instructed button among buttons 171 to 175.

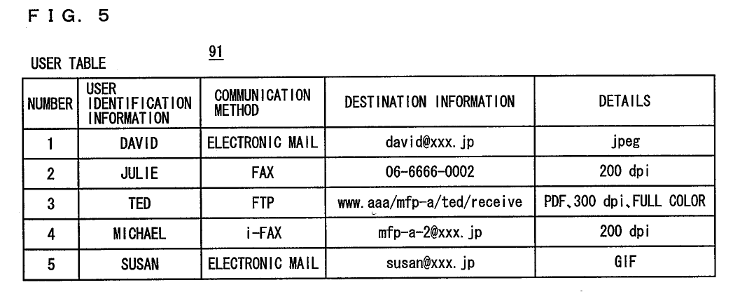

FIG. 5 is a diagram showing an example of the user table. User table 91 includes a user record that associates a communication method with destination information for each user. With reference to FIG. 5, the user record includes the item of number, the item of user identification information, the item of communication method, the item of destination information, and the item of details. In the item of number, a unique number given to the user record is set. For instance, it may be a serial number given in the order of registration to user table 91. In the item of user identification information, the user identification information for identifying a user is set. In the item of communication method, the communication method predetermined for the user is set. In the item of destination information, information related to the destination assigned to a user or an apparatus at the transmission destination according to the communication method is set. The information related to the destination is an electronic mail address assigned to a user when the communication method is electronic mail, a facsimile number assigned to the apparatus at the transmission destination when the communication method is FAX, location information of the transmission destination on network 2 when the communication method is FTP or SMB, and an electronic mail address assigned to the apparatus at the transmission destination when the communication method is i-FAX. Although a URL (Uniform Resource Locator) is used here as the location information of the transmission destination on network 2, an IP (Internet Protocol) address may be used as well.

Here, the facsimile number assigned to MFP 100A is “06-6666-0002,” and the electronic mail address assigned for i-FAX is “mfp-a-2@xxx.jp.” Moreover, the destination information “www.aaa/mfp-a/ted/receive” associated with user identification information “Ted” is a URL indicating an area of HDD 107 provided in MFP 100A.

In the item of details, information related to the data is set such as the format, the resolution, and the distinction of color or black-and-white of the data to be transmitted.

Going back to FIG. 3, destination designation portion 53 accepts the designation of a user of the user identification information corresponding to a 5 button instructed by the user transmitting the data among buttons 171 to 175 included in job setting window 150 shown in FIG. 4. Then, destination designation portion 53 obtains the information of the data to be transmitted, the destination information, and the communication method associated with the designated user in user table 91, and outputs these to data transmission portion 55. When a plurality of users are designated, destination designation portion 53 obtains the information of the data to be transmitted, the destination information, and the communication method associated with each of the plurality of users, and outputs these to data transmission portion 55.

Data transmission portion 55 generates a job ID and transmits the generated job ID, the data inputted from data designation portion 51, the user identification information at the origin of transmission, and the user identification information at the transmission destination to the destination indicated in the destination information inputted from destination designation portion 53 using the communication method inputted from destination designation portion 53. A job ID is the information for identifying a job of transmitting data and is unique information. For instance, it may be characters combining the apparatus identification information for identifying MFP 100 with a serial number or a time and date. The user identification information at the origin of transmission is the user identification information of the user (log-in user) who instructed the transmission of the data, and the user identification information at the transmission destination is the user identification information of the user designated to be the transmission destination.

For example, in the case where destination designation portion 53 accepts the instruction of button 171 included in job setting window 150 shown in FIG. 4, the communication method “electronic mail,” the destination information “david@xxx.jp,” and “jpeg” as the information related to the data are inputted from destination designation portion 53 into data transmission portion 55. Data transmission portion 55 converts the data into JPEG (Joint Photographic Experts Group) format, sets the address of the transmission destination as “david@xxx.jp,” generates an electronic mail that includes the job ID and the data in JPEG format, and causes communication I/F 111 to transmit the generated electronic mail to electronic mail server 300.

Moreover, in the case where destination designation portion 53 accepts the instruction of button 172 included in job setting window 150 shown in FIG. 4, the communication method “FAX,” the destination information “06-6666-0002,” and “200 dpi” as the information related to the data are inputted from destination designation portion 53 into data transmission portion 55. Data transmission portion 55 converts the data to the resolution of 200 dpi, and causes FAX 117 to transmit an image of the job ID and the converted data to MFP 100A to which the facsimile number “06-6666-0002” is assigned.

In the case where destination designation portion 53 accepts the instruction of button 173 included in job setting window 150 shown in FIG. 4, the communication method “FTP,” the destination information “www.aaa/mfp-a/ted/receive,” and “PDF, 300 dpi, full color” as the information related to the data are inputted from destination designation portion 53 into data transmission portion 55. Data transmission portion 55 converts the data into PDF (Portable Document Format) format, the resolution of 300 dpi, and full color, and causes communication I/F 111 to transmit the job ID and the data using the communication protocol of FTP to MFP 100A to which the URL “www.aaa/mfp-a/ted/receive” is assigned.

In the case where destination designation portion 53 accepts the instruction of button 174 included in job setting window 150 shown in FIG. 4, the communication method “i-FAX,” the destination information “mfp-a-2@xxx.jp,” and “200 dpi” as the information related to the data are inputted from destination designation portion 53 into data transmission portion 55. Data transmission portion 55 converts the data to the resolution of 200 dpi, sets the address of the transmission destination as “mfp-a-2@xxx.jp,” generates an electronic mail that includes the job ID and the converted data, and causes communication I/F 111 to transmit the generated electronic mail to electronic mail server 300. Since the electronic mail address “mfp-a-2@xxx.jp” is assigned to MFP 100A, the electronic mail is received by MFP 100A and the data included in the electronic mail is printed out by MFP 100A.

In addition, after transmitting the data, data transmission portion 55 outputs the job ID, the user identification information of the user who instructed the data transmission, and the user identification information of the user designated as the destination to transmission history storage portion 57. The user identification information of the user who logged into MFP 100 can be set as the user identification information of the user who instructed the data transmission.

Transmission history storage portion 57 generates a transmission history record that indicates that data transmission portion 55 has transmitted data, and adds the record to transmission history information 93 stored in HDD 107. Thus, transmission history information 93 is stored in HDD 107. Transmission history information 93 includes the transmission history record that is additionally stored every time data transmission portion 55 transmits data.

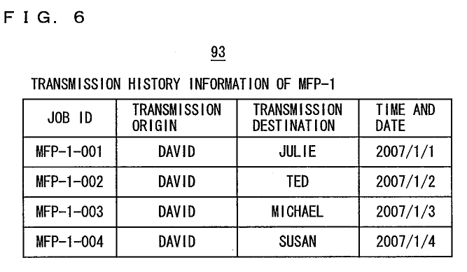

FIG. 6 is a diagram showing an example of transmission history information. With reference to FIG. 6, a transmission history record includes the item of a job ID, the item of transmission origin, the item of transmission destination, and the item of time and date. In the item of job ID, the item of transmission origin, and the item of transmission destination, respectively, the job ID outputted by data transmission portion 55, the user identification information of the user instructing the data transmission, and the user identification information of the user designated as the destination are set. In the item of time and date, the time and date at which data transmission portion 55 transmitted the data is set. Here, the transmission history record is shown indicating that the user identification information “David” transmitted data to user identification information “Julie,” “Ted,” “Michael,” and “Susan.”

In the case of this transmission job, the communication method “FAX” is associated with the user identification information “Julie” by user table 91 so that the data is transmitted to MFP 100A by the communication method “FAX,” the communication method “FTP” is associated with the user identification information “Ted” by user table 91 so that the data is transmitted to MFP 100A by the communication method “FTP,” and the communication method “i-FAX” is associated with the user identification information “Michael” by user table 91 so that the data is transmitted to MFP 100A by the communication method “i-FAX.” On the other hand, the communication method “electronic mail” is associated with the user identification information “Susan” by user table 91 so that the data is transmitted to electronic mail server 300. In the following description, the case where electronic mail transmitted by MFP 100 is received by the user identification information “Susan” at PC 200 will be described as an example.

Going back to FIG. 3, when communication I/F 111 or FAX 117 receives reply data for the data transmitted by data transmission portion 55, reply data accepting portion 59 accepts the reply data received by communication I/F 111 or FAX 117. While the reply data will be described later, it includes the user identification information for identifying the user that instructed the transmission of the reply data, the job ID included in the data transmitted by data transmission portion 55, and the destination information.

When communication I/F 111 receives data from outside, reply data accepting portion 59 determines whether the received data includes a job ID or not. Then, when the data includes a job ID, and if a transmission history record including the same job ID as the job ID included in the data is included in transmission history information 93 stored in HDD 107, the data received by communication I/F 111 is determined to be the reply data. Moreover, when FAX 117 receives facsimile data from outside, reply data accepting portion 59 subjects the received facsimile data to character recognition, and determines whether the string extracted from the data by character recognition includes the job ID or not. Then, when the facsimile data includes the string of the job ID, and if a transmission history record including the same job ID as the job ID included in the facsimile data is included in transmission history information 93 stored in HDD 107, the facsimile data received by FAX 117 is determined to be the reply data.

Further, reply data accepting portion 59 determines the communication method by which communication I/F 111 received the reply data. More specifically, if communication I/F 111 received the reply data by the communication protocol of electronic mail, reply data accepting portion 59 determines that the reception was done by the communication method of “electronic mail,” and if communication I/F 111 received the reply data by the communication protocol of i-FAX, it determines that the reception was done by the communication method of “i-FAX.” If communication I/F 111 received the reply data by the communication protocol of FTP, reply data accepting portion 59 determines that the reception was done by the communication method of “FTP,” and if communication I/F 111 received the reply data by the communication protocol of SMB, it determines that the reception was done by the communication method of “SMB.”

Reply data accepting portion 59 outputs the communication method by which the reply data was received, the destination information, and the user identification information included in the reply data to comparing portion 61.

Comparing portion 61 compares the communication method inputted from reply data accepting portion 59 with the communication method stored in user table 91 and associated with the user identification information inputted from reply data accepting portion 59. Comparing portion 61 outputs an update instruction to update portion 63 if the methods do not match, and outputs no update instruction if they do match. The update instruction includes the user identification information, the communication method, and the destination information inputted from reply data accepting portion 59.

When the update instruction is inputted, update portion 63 updates the item of communication method and the item of destination information in the user record that includes the user identification information inputted from comparing portion 61 among the user records stored in HDD 107, with the communication method and the destination information included in the update instruction, respectively. In this manner, the communication method and the destination information are changed for the user that transmitted back in reply the data transmitted by data transmission portion 55.

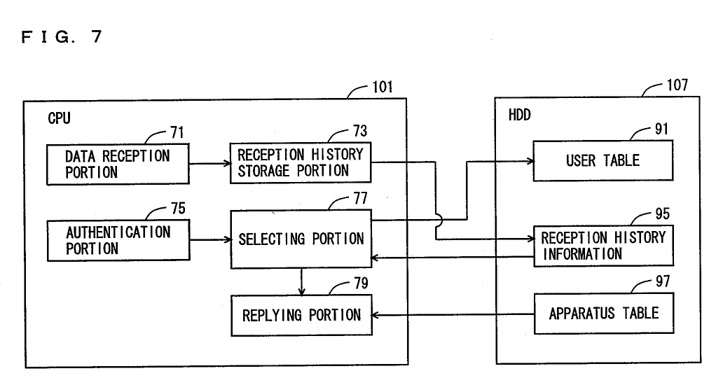

FIG. 7 is a functional block diagram showing, along with information stored in a HDD, an example of a function of a CPU provided in an MFP that functions as a data reception apparatus. With reference to FIG. 7, HDD 107 provided in MFP 100A that functions as the data reception apparatus stores an apparatus table 97.

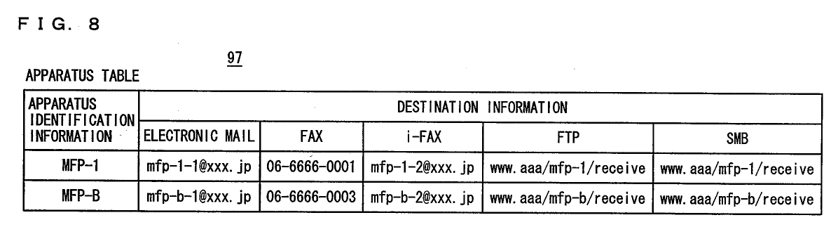

FIG. 8 is a diagram showing an example of an apparatus table. Apparatus table 97 includes an apparatus record that associates the destination information for each of the communication methods assigned to each apparatus, in relation to each data communication apparatus other than its own apparatus, i.e. MFP 100A here, among data communication apparatuses that constitute a data communication system. Here, the data communication apparatuses included in an information processing system 1 are MFPs 100, 100A, 100B, 100C, and PC 200 and PC 200A so that apparatus table 97 includes the apparatus record that associates the destination information for each of the communication methods assigned to each apparatus in relation to each of MFPs 100, 100B, 100C, and PC 200 and PC 200A but not MFP 100A.

With reference to FIG. 8, the apparatus record includes the item of apparatus identification information and the item of the destination information for each communication method. Here, only the apparatus records corresponding to MFP 100 and MFP 100B are shown. With apparatus identification information “MFP-1” of MFP 100, the destination information “mfp-1-1xxxjp” is associated corresponding to the communication method “electronic mail,” the destination information “06-6666-0001” is associated corresponding to the communication method “FAX,” the destination information “mfp-1-2@xxxjp” is associated corresponding to the communication method “i-FAX,” and the destination information “www.aaa/mfp-1/receive” is associated corresponding to the communication methods “FTP” and “SMB.”

With apparatus identification information “MFP-B” of MFP 100B, the destination information “mfp-b-1@xxxjp” is associated corresponding to the communication method “electronic mail,” the destination information “06-6666-0003” is associated corresponding to the communication method “FAX,” the destination information “mfp-b-2@xxx.jp” is associated corresponding to the communication method “i-FAX,” and the destination information “www.aaa/mfp-b/receive” is associated corresponding to the communication methods “FTP” and “SMB.”

Going back to FIG. 7, CPU 101 provided in MFP 100A that functions as the data reception apparatus includes a data reception portion 71 for receiving data, a reception history storage portion 73 for storing reception history, an authentication portion 75 for authenticating a user, a selecting portion 77 for selecting one reception history record from reception history records, and a replying portion 79 for transmitting data back in reply.

Data reception portion 71 accepts the data received by communication I/F 111 or FAX 117. Data reception portion 71 extracts the job ID, the user identification information of the transmission origin, the user identification information of the transmission destination, the time and date of the transmission, and the apparatus identification information identifying the apparatus at the transmission origin from the information transmitted along with the received data. Further, data reception portion 71 determines the communication method by which communication I/F 111 received the data. More specifically, if communication I/F 111 received the data by the communication protocol of electronic mail, it determines that the reception was done by the communication method of “electronic mail;” if communication I/F 111 received the data by the communication protocol of i-FAX, it determines that the reception was done by the communication method of “i-FAX;” and if communication I/F 111 received the data by the communication protocol of FTP, it determines that the reception was done by the communication method of “FTP.” Data reception portion 71 determines that the reception was done by the communication method of “FAX” if FAX 117 received the data.

Data reception portion 71 outputs to reception history storage portion 73 the job ID, the user identification information of the transmission origin, the user identification information of the transmission destination, the time and date of the transmission, and the apparatus identification information identifying the apparatus at the transmission origin extracted from the information transmitted along with the received data.

Reception history storage portion 73 generates a reception history record based on the information inputted from data reception portion 71, and adds the reception history record to reception history information 95 stored in HDD 107. Reception history information 95 includes the reception history record additionally stored every time data reception portion 71 receives data.

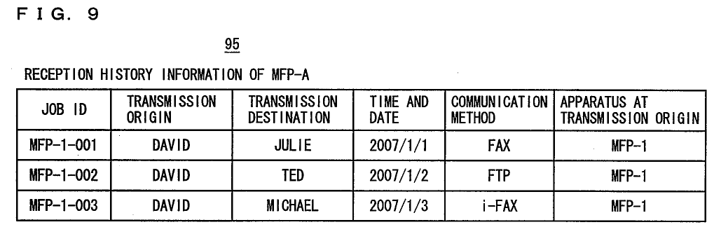

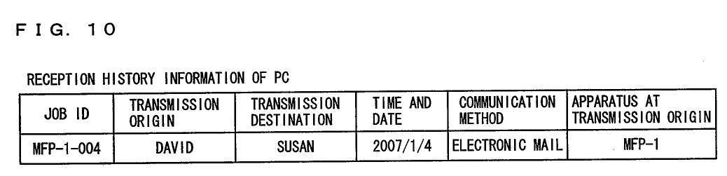

FIG. 9 is a diagram showing an example of the reception history information. The reception history record included in the reception history information includes the item of the job ID, the item of the transmission origin, the item of the transmission destination, the item of time and date, the item of the communication method, and the item of the apparatus at transmission origin. In the item of the job ID, the item of the transmission origin, the item of the transmission destination, the item of time and date, and the item of the apparatus at transmission origin, respectively, the job ID, the user identification information of the transmission origin, the user identification information of the transmission destination, the time and date of the transmission, and the apparatus identification information of the apparatus at the transmission origin extracted from the information transmitted along with the received data are set, and in the item of the communication method, the communication method corresponding to the communication protocol by which the data was received is set.

Although the case where a reception history record includes the item of the job ID, the item of the transmission origin, the item of the transmission destination, the item of time and date, the item of the communication method, and the item of the apparatus at transmission origin has been described as an example here, the reception history record at least needs to include the item of the job ID and the item of the apparatus at transmission origin. It is preferable, however, that an item is included that allows the user who obtained the received data to specify the particular reception history record that was stored upon the reception of the data transmitted to the user himself from among the reception history records included in reception history information 95.

Further, while the data that MFP 100 transmitted to the user identification information “Susan” by electronic mail is received at PC 200, reception history information is stored in the HDD provided in PC 200 in the same manner as it is done in MFP 100A.

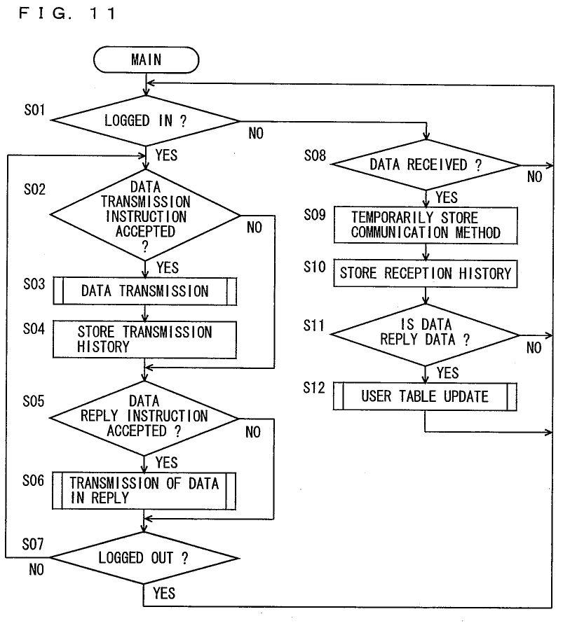

FIG. 10 is a diagram showing an example of the reception history information stored in a PC. The operation in PC 200 is similar to that in MFP 100A so that the description will be given taking MFP 100 as an example.

Going back to FIG. 7, authentication portion 75 authenticates the user using MFP 100A. More specifically, a log-in window is displayed on display portion 119B, and when the user using MFP 100A inputs the user identification information and a password into input portion 119A, it is determined whether these are stored in HDD 107 in advance or not. If the user identification information and the password inputted into input portion 119A by the user are stored in advance in the HDD, authentication portion 75 authenticates the user and outputs the user identification information of the authenticated user to selecting portion 77. In addition, although the user identification information and a password are used for authentication here, biological information such as a fingerprint, a vein pattern, an iris, and a sound spectrogram may also be used for the authentication.

Selecting portion 77 accepts an instruction by the authenticated user designating one of the reception history records included in reception history information 95. More specifically, the reception history records included in reception history information 95 are displayed on display portion 119B, and when the authenticated user inputs into input portion 119A an operation instructing which one of the displayed reception history records to designate, selecting portion 77 accepts the designation of the reception history record.

Moreover, selecting portion 77 displays on display portion 119B a selection window for accepting the destination information and one selected choice from all the communication methods by which MFP 100A is capable of transmitting and receiving data, and accepts the destination information and the instruction of the user selecting a communication method. Since MFP 100A is capable of transmitting and receiving data by the communication methods of “electronic mail,” “FAX,” “i-FAX,” “FTP,” and “SMB” here, one of these communication methods is selected and the destination information corresponding to the selected communication method is accepted. Selecting portion 77 outputs to replying portion 79 the designated reception history record, the accepted destination information, and the instruction to transmit by the selected communication method.

Furthermore, selecting portion 77 updates user table 91 using the selected communication method and the accepted destination information. More specifically, selecting portion 77 updates the item of the destination information and the item of the communication method of the user record that includes the user identification information of the log-in user among the user records in user table 91 with the selected communication method and the accepted destination information.

Replying portion 79 refers to apparatus table 97 stored in HDD 107 and obtains the destination information that corresponds to the communication method selected by selecting portion 77 and that is associated with the apparatus identification information set in the item of the apparatus at transmission origin of the reception history record inputted from selecting portion 77. Thereafter, replying portion 79 transmits to the obtained destination information the job ID set in the item of the job ID in the reception history record inputted from selecting portion 77, the destination information inputted by the authenticated user, and the user identification information of the authenticated user using the communication method selected by selecting portion 77. In this manner, reply data is received by MFP 100 that functions as the data transmission apparatus. The job ID, the destination information inputted by the authenticated user, and the user identification information of the authenticated user may be included in a header portion of the data to be transmitted, or they may be converted into an image and the image may be transmitted. Further, when the user designates the data to be transmitted, the designated data is transmitted along with the job ID, the destination information, and the user identification information.

When the user of the user identification information “Julie” logs in at MFP 100A that functions as the data reception apparatus, selects the reception history record which has the transmission destination “Julie” among reception history information 95 shown in FIG. 9, selects electronic mail as the communication method, and inputs “julie@xxx.jp” as the destination information, an electronic mail that includes the job ID “MFP-1-001,” the user identification information “Julie,” and the destination information “julie@xxx.jp” and that sets “mfp-1-1@xxx.jp” assigned to MFP 100 as the electronic mail address of its destination is generated, and is transmitted to electronic mail server 300. This electronic mail is received as reply data by MFP 100.

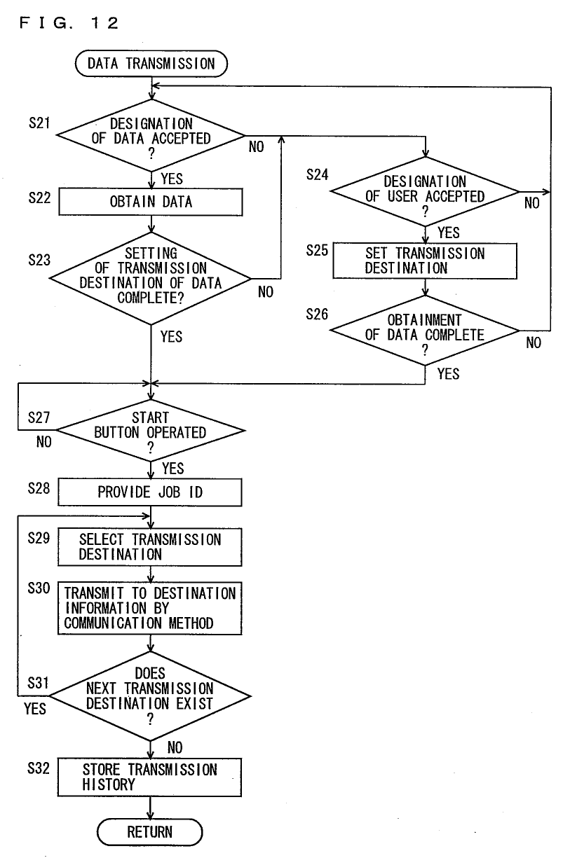

FIG. 11 is a flow chart showing an example of the flow of a main process. The main process is the process executed by each CPU provided in each of MFPs 100, 100A, 100B, 100C, and PC 200 and PC 200A executing a transmission destination update program. Here, for illustration, the case where CPU 101 in MFP 100 that functions as the data transmission apparatus and CPU 101 in MFP 100A that functions as the data reception apparatus respectively execute the transmission destination update program will be described as an example.

CPU 101 of each of MFP 100 and MFP 100A determines whether the log-in of a user is accepted or not (step S01). A log-in window is displayed on display portion 119B, and it is determined whether the user identification information and the password the user inputs into input portion 119A are stored in HDD 107 in advance or not. When the user identification information and the password are accepted, and if they were stored in HDD 107 in advance, the log-in is accepted, and the process moves on to step S02, but if not, the process moves on to step S08.

In step S08, it is determined whether data is received from outside or not. If communication I/F 111 or FAX 117 has received the data, the process proceeds to step S09, and if not, the process goes back to step S01. In other words, the main process is a process that is executed when the log-in of a user is accepted or when data is received from outside.

In step S02, it is determined whether a data transmission instruction is received or not. If the data transmission instruction is accepted, the process moves on to step S03, and if not, the process moves on to step S05. If an instruction to display job setting window 150 inputted into input portion 119A by the user is detected, the data transmission instruction is accepted.

In step S03, the data transmission process is executed. While the data transmission process will be described later, it is a process of transmitting data to the user designated as the destination. In the next step S04, transmission history information 93 indicating that the data has been transmitted is stored in HDD 107. More specifically, a transmission history record including the job ID for identifying the job of transmitting data, the user identification information of the user (log-in user) who instructed the data transmission, the user identification information of the user to whom the data is to be transmitted, and the time and date of the data transmission is generated, and is added to transmission history information 93 stored in HDD 107.

In step S05, it is determined whether a reply instruction for the data is accepted or not. If the reply instruction for the data is accepted, the process proceeds to step S06, and if not, the process proceeds to step S07. The reply instruction for the data is accepted when the user instructs on a reply button predetermined on input portion 119A.

In step S06, a data reply process is executed. While the data reply process will be described later, it is a process of transmitting data back in reply to the data received from outside in step S08 described below. In step S07, it is determined whether the user that had logged in has logged out or not. If the user had logged out, the process goes back to step S01, and if not, the process goes back to step S02.

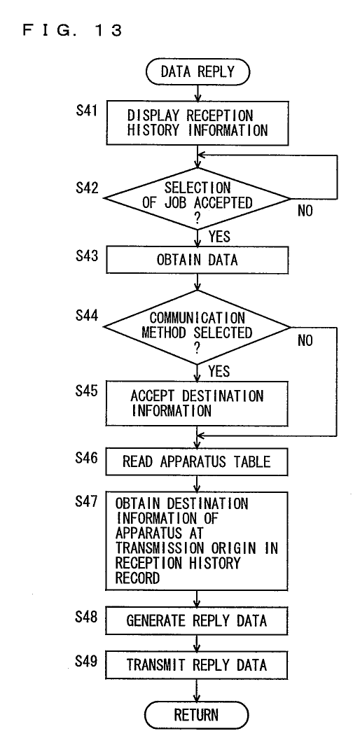

FIG. 12 is a flow chart showing an example of the flow of the data transmission process. The data transmission process is the process that is executed in step S03 of the main process shown in FIG. 11. Here, the data transmission process is executed by CPU 101 provided in MFP 100 that functions as the data transmission apparatus.

With reference to FIG. 12, CPU 101 displays job setting window 150 shown in FIG. 4 on display portion 119B, and determines whether the designation of the data to be the object of transmission had been accepted or not (step S21). If the instruction designating the data is accepted, the process moves on to step S22, but if not, the process moves on to step S24.

In step S22, the designated data is obtained. More specifically, when the image data to be outputted by scanner 113 having scanned a sheet of original manuscript is designated, scanner 113 is activated and the image data outputted by scanner 113 is obtained, and when data stored in flash ROM 108 or HDD 107 is designated, the designated data is read from flash ROM 108 or HDD 107.

Then, in step S23, it is determined whether the setting of the transmission destination of the data is completed or not. If the setting of the transmission destination is completed, the process proceeds to step S27, but if not, the process proceeds to step S24. In step S24 described below, if at least one of buttons 171 to 175 included in job setting window 150 is selected and a finish button provided in input portion 119A is instructed, the setting of the transmission destination of the data is determined to have been completed.

In step S24, it is determined whether the designation of the user as the transmission destination of the data has been accepted or not. If the designation of the user has been accepted, the process moves on to step S25, and if not, the process goes back to step S21. When at least one of buttons 171 to 175 is instructed in job setting window 150, the designation of the user as the transmission destination of the data is accepted. In step S25, a set of destination information and the communication method of the designated user is set as the transmission destination. More specifically, the user record including the user identification information corresponding to the instructed button among buttons 171 to 175 is extracted from user table 91 stored in HDD 107, and the set of the destination information and the communication method respectively set in the item of destination information and in the item of the communication method in the extracted user record is set as the transmission destination. Moreover, there are cases where step S24 and step S25 are executed multiple times until the finish button provided in input portion 119A is instructed. In such cases, multiple sets of the destination information and the communication method are set as the transmission destinations.

In the next step S26, it is determined whether data is obtained in step S22 or not. If the data is obtained, the process proceeds to step S27, but if not, the process goes back to step 21 in order to accept the designation of the data.

The process proceeds to step S27 when the data to be the object of transmission is obtained in step S22 and the transmission destination is set in step S25. In step S27, the process stands by until a start button provided on input portion 119A is operated (NO in step S27), and when the start button is pressed (YES in step S27), the process moves on to step S28.

In step S28, a job ID is given. Here, the job ID is “MFP-1-001,” which is a combination of the apparatus identification information “MFP-1” of MFP 100 and a serial number “001.”

Next, one of the sets of the destination information and the communication method set as a transmission destination in step S29 is selected as the object of processing. This is because, in some cases, a plurality of sets of the destination information and the communication method are set as the transmission destinations. The multiple sets set as the transmission destinations are set one by one as the object of processing.

In step S30, the job ID, the user identification information of the transmission origin, the user identification information of the transmission destination, and the data obtained in step S22 are transmitted to the destination information by the communication method included in the set which is the object of processing. Moreover, only the job ID and the data obtained in step S22 may be transmitted to the destination information by the communication method included in the set which is the object of processing. The job ID is the job ID given in step S28, the user identification information of the transmission origin is the user identification information of the user (log-in user) who instructed the transmission of the data, and the user identification information of the transmission destination is the user identification information of the user designated in step S24.

In the next step S31, it is determined whether a set that has not yet been set as the object of processing exists or not among the sets of destination information and communication method set as the transmission destinations. If such a set exists, the process goes back to step S29, and if not, the process moves on to step S32. In this manner, step S30 is executed on every one of the multiple sets set as the transmission destinations so that, for all the sets set as the transmission destinations, the job ID and the data obtained in step S22 are transmitted to the destination information using the communication method included in each set.

In step S32, transmission history information 93 is stored in HDD 107. More specifically, one transmission history record is generated every time data is transmitted, and is additionally stored in transmission history information 93 stored in HDD 107. A transmission history record includes the job ID given in step S28, the user identification information of the user who instructed the transmission of the data, here, namely, the log-in user, the user identification information of the user designated in step S24, and the time and date of the transmission.

Here, the case where the user of the user identification information “David” logs in at MFP 100, designates the data, designates buttons 172 to 175 included in job setting window 150, and instructs the finish button and the start button will be described as an example. In this case, MFP 100 functions as the data transmission apparatus, transmits the data, and stores the transmission history information shown in FIG. 6 in HDD 107. Buttons 172 to 175 respectively correspond to user identification information “Julie,” “Ted,” “Michael,” and “Susan.” Now, with reference to user table 91 shown in FIG. 5, the communication methods respectively corresponding to the user identification information “Julie,” “Ted,” “Michael,” and “Susan” are “FAX,” “FTP,” “i-FAX,” and “electronic mail” so that the data is respectively transmitted by different communication methods. Here, all the destination information of the user identification information “Julie,” “Ted,” and “Michael” are assigned to MFP 100A so that the data transmitted respectively to the user identification information “Julie,” “Ted,” and “Michael” are received at MFP 100A.

Now, going back to FIG. 11, the case where CPU 101 provided in MFP 100A executes the process from step S08 to step S10 will be described as an example. In step S08, it is determined whether data is received from outside or not. If the reception of data is detected, the process move on to step S09, but if the reception is not detected, the process goes back to step S01. In step S09, the communication method by which the data was received is obtained, and the obtained communication method is temporarily stored in RAM 105. If communication I/F 111 received electronic mail by the communication protocol of electronic mail, the communication method of “electronic mail” is obtained; if communication I/F 111 received the data by the communication protocol of i-FAX, the communication method of “i-FAX” is obtained; if communication I/F 111 received the data by the communication protocol of FTP, the communication method of “FTP” is obtained; if communication I/F 111 received the data by the communication protocol of SMB, the communication method of “SMB” is obtained; and if FAX 117 received facsimile data, the communication method of “FAX” is obtained.

In the next step S10, a reception history record indicating that the data has been received is generated, and is added to reception history information 95 stored in HDD 107. More specifically, a reception history record which includes the job ID, the user identification information of the transmission origin, the user identification information of the transmission destination, the time and date of the transmission, and the apparatus identification information of the apparatus at the transmission origin extracted from the information transmitted along with the data received in step S08, and the communication method by which the data was received, is generated, and the generated reception history record is added to reception history information 95 stored in HDD 107. Thus, reception history information 95 shown in FIG. 9 is stored in HDD 107.

Now, the data reply process executed in step S06 will be described. The data reply process is a process executed by the data reception apparatus that received the data. Since MFP 100A receives the data from MFP 100 in the above-described step S08, the instance where CPU 101 of MFP 100A that functions as the data reception apparatus executes the data reply process will be described here as an example.

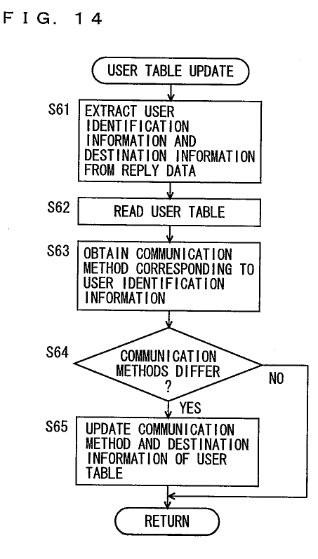

FIG. 13 is a flow chart showing an example of the flow of the data reply process. With reference to FIG. 13, CPU 101 of MFP 100A that functions as the data reception apparatus displays reception history information 95 stored in HDD 107 on display portion 119B (step S41). Here, the case where the user of the user identification information “Julie” logged in at MFP 100A will be described as an example. In this example, among the reception history information 95 shown in FIG. 9, the reception history record which has the user identification information “Julie” of the log-in user set in the item of the transmission destination is displayed on display portion 119B. Thus, the log-in user can specify the job which transmitted the data to be the object of reply even when multiple data have been transmitted addressed to him.

In step S42, the process stands by until the selection of a job is accepted (NO in step S42), and when the selection of the job is accepted (YES in step S42), the process moves on to step S43. The selection of the job is accepted if an instruction that selects one of the displayed reception history records is accepted. In step S43, designation of the data to be transmitted in reply is accepted, and the designated data is obtained.

Next, a selection window for selecting a communication method is displayed on display portion 119B, and it is determined whether an instruction that selects one of the plurality of communication methods displayed on the selection window is accepted or not (step S44). If the communication method is selected, the process proceeds to step S45, but if it is not selected, step S45 is skipped, and the process proceeds to step S46.

When the process proceeds to step S45, the selected communication method is set as the communication method for transmitting the data. On the other hand, when the communication method is not selected and the process proceeded to step S46, the communication method preset for the log-in user is set as the communication method. The preset communication method is the communication method associated with the user identification information of the log-in user in user table 91 stored in HDD 107.

In step S45, the destination information corresponding to the selected communication method is accepted. This is to specify the destination of the transmission by the selected communication method since a different communication method from that stored in user table 91 has been selected. At this time, user table 91 is updated with the selected communication method and the accepted destination information. In this manner, user table 91 stored in HDD 107 of MFP 100 that functions as the data reception apparatus is updated.

In the next step S46, apparatus table 97 stored in HDD 107 is read. Apparatus table 97 shown in FIG. 8 is read. Then, an apparatus record that includes the apparatus identification information set in the item of the apparatus at transmission origin in the reception history record selected in step S42 is extracted from apparatus table 97, and from the destination information set in the extracted apparatus record, the destination information corresponding to the communication method selected in step S44 is obtained (step S47). Here, the apparatus identification information “MFP-1” of MFP 100 is set in the item of the apparatus at transmission origin in the reception history record selected in step S42, the apparatus record that includes the apparatus identification information “MFP-1” is extracted from apparatus table 97, and from the destination information set in the extracted apparatus record, the destination information corresponding to the communication method selected in step S44 is obtained (step S47).

In the next step S48, reply data is generated. The reply data includes the job ID included in the reception history record selected in step S42, the user identification information of the log-in user, i.e. “Julie” here, the destination information accepted in step S45, and the data obtained in step S43. Then, the reply data generated in step S48 is transmitted to the destination information obtained in step S47 by the communication method selected in step S44, and the process returns to the main process.

When the log-in user “Julie” selects the communication method “electronic mail” in step S44 and inputs the destination information “julie@xxx.jp” in step S45, an electronic mail which includes the reply data including the job ID “MFP-1-001,” the user identification information “Julie,” and the destination information “julie@xxx.jp” and whose destination address is the electronic mail address “mfp-1-1xxx.jp” assigned to MFP 100 is transmitted to electronic mail server 300. This electronic mail is received at MFP 100 that functions as the data transmission apparatus.

Next, going back to FIG. 11, the case where CPU 101 provided in MFP 100 that functions as the data transmission apparatus executes the process of step S08 and beyond will be described as an example. CPU 101 provided in MFP 100 that functions as the data transmission apparatus determines whether data is received from outside or not in step S08. Since MFP 100A that functions as the data reception apparatus has executed the data reply process and has transmitted an electronic mail addressed to MFP 100 earlier, here, communication I/F 111 receives the electronic mail and the process moves on to step S09.

In step S09, the communication method by which the data was received is temporarily stored in RAM 105. Here, since the electronic mail is received, the communication method of “electronic mail” is temporarily stored. Then, a reception history record indicating that the data was received is generated and added to reception history information 95 stored in HDD 107 (step S10).

In the next step S11, it is determined whether the received data is reply data or not. If the received data is the reply data, the process proceeds to step S12, but if not, the process goes back to step S01. In this manner, a user table update process in the next step S12 is only executed for reply data.

As described using FIG. 12, in the data transmission process, while the job ID is transmitted along with the data to be transmitted (step S30), the transmission history record including that job ID is also added to transmission history information 93 stored in HDD 107 (step S32). Moreover, when MFP 100A that functions as the data reception apparatus executes the data reply process, reply data that includes the job ID included in the data that became the basis for the reply is transmitted. Thus, it is determined whether transmission history information 93 stored in HDD 107 includes the transmission history record that has the same job ID as the job ID included in the received data set in the item of the job ID or not. If transmission history information 93 includes such transmission history record, it is determined that the received data is the reply data, and if not, the data is not determined to be the reply data. Here, MFP 100A that functions as the data reception apparatus transmits the electronic mail including the reply data and that electronic mail is received so that the process moves on to step S12. In step S12, the user table update process is executed, and the process returns to step S01.

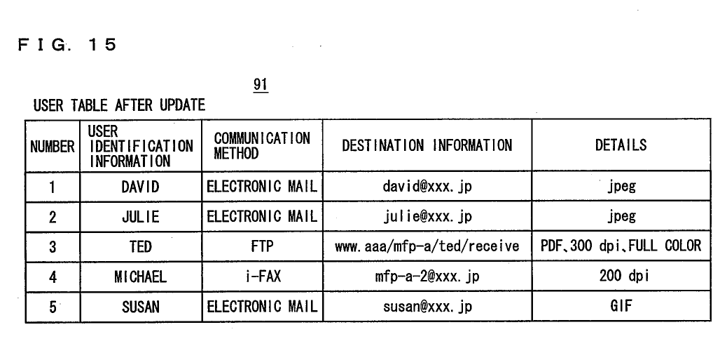

FIG. 14 is a diagram showing an example of the flow of the user table update process. The user table update process is a process executed by CPU 101 provided in MFP 100 that functions as the data transmission apparatus.

With reference to FIG. 14, CPU 101 provided in MFP 100 that functions as the data transmission apparatus extracts the user identification information and the destination information included in the reply data (step S61). Here, the user identification information “Julie” and the destination information “julie@xxx.jp” are extracted from the reply data. Then, user table 91 stored in HDD 107 is read (step S62).

Next, the communication method set in user table 91 as corresponding to the user identification information “Julie” is obtained. More specifically, the communication method “FAX” which is set in the item of the communication method in the user record including the user identification information “Julie” extracted in step S61 is obtained from the read user table 91.

Then, it is determined whether the communication method by which the reply data was received is different from the communication method obtained in step S63 or not. If they are different, the process proceeds to step S65, but if they are the same, the process goes back to the main process. The communication method by which the reply data was received is “electronic mail” stored in RAM 105 in step S09 of FIG. 11. Thus, here, the process proceeds to step S65.

In step S65, the communication method and the destination information in user table 91 are updated with the communication method by which the reply data was received and with the destination information extracted from the reply data in step S61. More specifically, the item of the communication method and the item of the destination information of the user record which has the user identification information “Julie” that is extracted from the reply data in step S61 set in the item of user identification information of user table 91 stored in HDD 107 are updated with the communication method “electronic mail” temporarily stored in RAM 105 and with the destination information “julie@xxx.jp” extracted from the reply data in step S61.

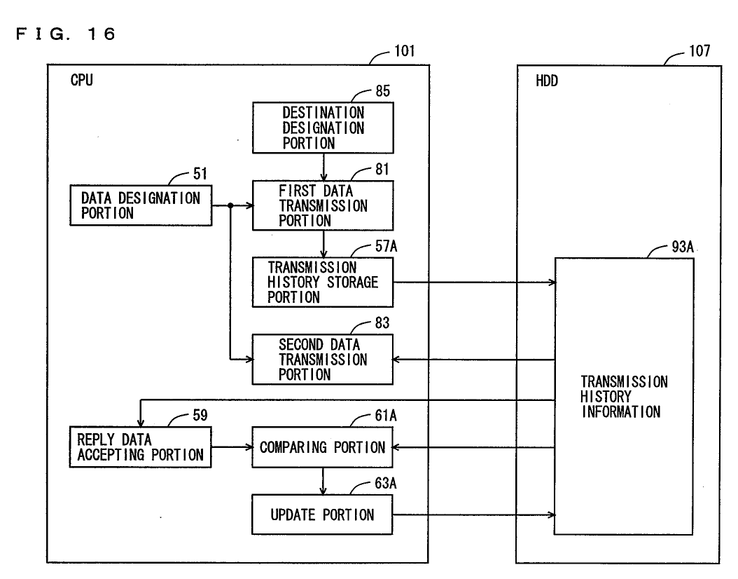

FIG. 15 is a diagram showing an example of the user table after an update. With reference to FIG. 15, in comparison with user table 91 shown in FIG. 5, the item of the communication method and the item of the destination information of the user record including the user identification information “Julie” are different.

Due to the fact that MFP 100A that functions as the data reception apparatus receives the data transmitted by David from MFP 100 that functions as the data transmission apparatus, the user of the user identification information “Julie” can obtain the data by the communication method “FAX” registered in user table 91. Thereafter, if the user of the user identification information “Julie” wishes to receive the data not by the communication method of “FAX” but by the communication method of “electronic mail,” the user may have MFP 100A that functions as the data reception apparatus transmit by electronic mail the reply data for the data received by the communication method “FAX,” thereby causing user table 91 stored in HDD 107 provided in MFP 100 that functions as the data transmission apparatus to be updated. Thus, the user receiving the data can easily alter the communication method predetermined in user table 91 by the simple operation of transmitting the data back in reply. In addition, the receiver of the data himself may set the communication method by which the data is to be received.

### [Modification]

In data communication system 1 according to the above-described embodiment, MFP 100A that functions as the data reception apparatus stores apparatus table 97 in HDD 107. In data communication system 1 according to the modification, MFP 100 that functions as the data transmission apparatus transmits along with the data the destination information for each of the plurality of communication methods assigned to MFP 100 itself. Thus, MFP 100A that functions as the data reception apparatus receives the destination information for each of the plurality of communication methods along with the data from MFP 100 that functions as the data transmission apparatus so that it can transmit the reply data to MFP 100. In this way, there is no need to store apparatus table 97 in HDD 107.

Moreover, while the user identification information “Susan” receives at PC 200 the electronic mail transmitted by MFP 100, if PC 200 functions as a data reception apparatus, PC 200 may function in the same manner as that described with regard to MFP 100A so that the user of the user identification information “Susan” can also update user table 91 stored in MFP 100.

### Second Embodiment

The arrangement of the data communication system according to the second embodiment is the same as the arrangement of the data communication system according to the first embodiment shown in FIG. 1. The hardware arrangement of a data transmission apparatus according to the second embodiment is the same as the hardware arrangement of the data transmission apparatus according to the first embodiment shown in FIG. 2. Data communication system 1 according to the first embodiment is one in which MFP 100 and MFP 100A that respectively function as a data transmission apparatus and a data reception apparatus store user table 91 in HDD 107. Data communication system 1 according to the second embodiment is one in which MFP 100 and MFP 100A that respectively function as the data transmission apparatus and the data reception apparatus do not store user table 91 in HDD 107. Hereinafter, the data communication system according to the second embodiment will be described mainly with regard to the points where it differs from the data communication system according to the first embodiment. Here also, the case where MFP 100 functions as a data transmission apparatus and MFP 100A functions as a data reception apparatus will be described as an example.

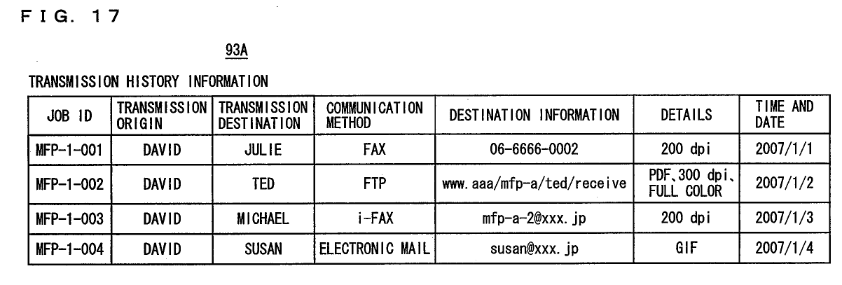

FIG. 16 is a functional block diagram showing, along with information stored in a HDD, an example of a function of a CPU provided in the MFP that functions as the data transmission apparatus according to the second embodiment of the present invention. With reference to FIG. 16, CPU 101 provided in MFP 100 that functions as the data transmission apparatus includes a data designation portion 51 for accepting designation of data to be transmitted, a destination designation portion 85 for accepting designation of a destination to which data is to be transmitted, a first data transmission portion 81 for transmitting the data, a transmission history storage portion 57A for storing history information indicating that the data has been transmitted, a second data transmission portion 83 for transmitting data to the same destination as that included in transmission history, a reply data accepting portion 59 for receiving reply data that is transmitted back in reply according to the data transmitted, a comparing portion 61A, and an update portion 63A.

The function of CPU 101 provided in MFP 100A that functions as the data reception apparatus according to the second embodiment is the same as the one in which HDD 107 does not have user table 91 in the functional block diagram shown as FIG. 7. Thus, the description thereof will not be repeated here.

With reference to FIG. 16, data designation portion 51 accepts designation of the data to be the object of transmission. Data designation portion 51 displays a data designation window on display portion 119B, and accepts the designation of the data when a user, according to the data designation window, inputs into input portion 119A an operation designating the data to be the object of transmission. The data designation window is a window that excludes area 152 for accepting an instruction of selection of an output end of the data from job setting window 150 shown in FIG. 4. Data designation portion 51 obtains the designated data, and outputs the obtained data to first data transmission portion 81.

Destination designation portion 85 displays a destination designation window on display portion 119B, and accepts the communication method inputted in input portion 119A by the user, the destination information assigned to the user to be the destination by that communication method, and information related to the data to be transmitted. The information related to the data to be transmitted is the format, the resolution, the distinction of color or black-and-white and the like of the data to be transmitted. Destination designation portion 85 outputs to first data transmission portion 81 the accepted communication method, the destination information, and the information related to the data to be transmitted. When a plurality of sets of the communication method, the destination information, and the information related to the data to be transmitted are accepted, destination designation portion 85 outputs the communication method, the destination information, and the information related to the data to be transmitted for each of the plurality of sets accepted to first data transmission portion 81.

Here, the case will be described where “FAX” as the communication method and the facsimile number “06-6666-0002 assigned to MFP 100A as the destination information are inputted for user identification information “Julie,” “FTP” as the communication method and the URL “www.aaa/mfp-a/ted/receive” assigned to an area of HDD 107 of MFP 100A as the destination information are inputted for user identification information “Ted,” “i-FAX” as the communication method and the electronic mail address “mfp-a-2@xxx.jp” assigned to MFP 100A as the destination information are inputted for user identification information “Michael,” and “electronic mail” as the communication method and the electronic mail address “susan@xxx.jp” assigned to the user identification information “Susan” as the destination information are inputted for the user identification information “Susan,” and where all are accepted by destination designation portion 85.

First data transmission portion 81 converts the data inputted from data designation portion 51 according to the information related to the data to be transmitted inputted from reception history information 95, generates a job ID, and transmits the converted data, the generated job ID, and the user identification information of the transmission destination to the destination information inputted from destination designation portion 85 by the communication method inputted from destination designation portion 85.

Transmission history storage portion 57A generates a transmission history record that indicates that first data transmission portion 81 has transmitted data, and stores it in HDD 107. Thus, transmission history information 93A is stored in HDD 107. The transmission history information includes transmission history records additionally stored every time first data transmission portion 81 transmits data.

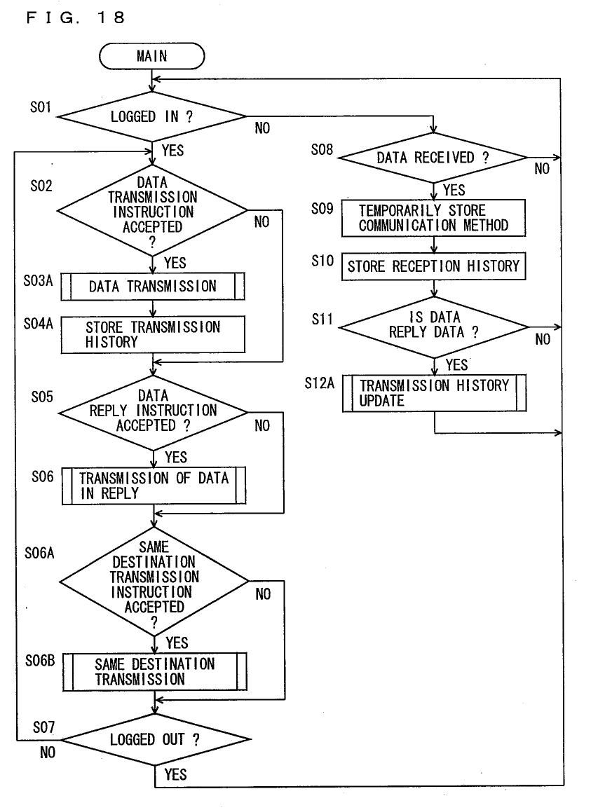

FIG. 17 is another diagram showing an example of the transmission history information. With reference to FIG. 17, a transmission history record includes the item of a job ID, the item of transmission origin, the item of transmission destination, the item of communication method, the item of destination information, the item of details, and the item of time and date. In the item of the job ID, the item of the transmission origin, and the item of the transmission destination, respectively, the job ID outputted by first data transmission portion 81, the user identification information of the user who instructed the data transmission, and the user identification information of the user designated as the destination are set. In the item of the communication method and the item of the destination information, the communication method by which first data transmission portion 81 transmitted the data and the destination information are respectively set. In the item of details, information related to the data to be transmitted is set. In the item of the time and date, the time and date at which first data transmission portion 81 transmitted the data is set. Here, the transmission history record is shown which indicates that the user of the user identification information “David” transmitted data to user identification information “Julie,” “Ted,” “Michael,” and “Susan.”

In the case of this transmission job, the data to be transmitted to the user identification information “Julie” is transmitted to MFP 100A by the communication method “FAX,” the data to be transmitted to the user identification information “Ted” is transmitted to MFP 100A by the communication method “FTP,” and the data to be transmitted to the user identification information “Michael” is transmitted to MFP 100A by the communication method “i-FAX.” On the other hand, as for the data to be transmitted to the user identification information “Susan,” the data is transmitted to electronic mail server 300.

Going back to FIG. 16, second data transmission portion 83 transmits data to the same destination using transmission history information 93A. Second data transmission portion 83 reads transmission history information 93A from HDD 107 and displays it on display portion 119B. In the case where the user of the user identification information “David” logs in at MFP 100, the transmission history record that has “David” set in the item of the transmission origin in transmission history information 93A shown in FIG. 17 is read and displayed on display portion 119B. If “David” designates a job ID, the transmission history record including that job ID is selected. Second data transmission portion 83 converts the data inputted from data designation portion 51 according to the information related to the data to be transmitted that is set in the item of details of the selected transmission history record, and transmits the converted data to the destination information set in the item of the destination information by the communication method set in the item of the communication method. Thus, when transmitting data to the same destination as one to which data was transmitted in the past, the user who logs in at MFP 100 that functions as the data transmission apparatus may transmit the data with ease, since there is no need to input the communication method and the destination information.

When communication I/F 111 or FAX 117 receives reply data for the data transmitted by first data transmission portion 81 or second data transmission portion 83, reply data accepting portion 59 accepts the reply data received by communication I/F 111 or FAX 117. The reply data includes the user identification information of the user who transmitted the reply data, the job ID included in the data transmitted by first data transmission portion 81 or second data transmission portion 83, and the destination information.

Further, reply data accepting portion 59 determines the communication method by which communication I/F 111 received the reply data. Then, reply data accepting portion 59 outputs the communication method by which the reply data was received, the destination information, and the user identification information included in the reply data to comparing portion 61A.

Comparing portion 61A compares the communication method set in the item of the communication method in the transmission history record that includes the user identification information and the job ID inputted from reply data accepting portion 59, with the communication method inputted from reply data accepting portion 59. Comparing portion 61A outputs an update instruction to update portion 63A if the methods do not match, and outputs no update instruction if they do match. The update instruction includes the job ID, the user identification information, the communication method, and the destination information inputted from reply data accepting portion 59.

When the update instruction is inputted, update portion 63A updates the item of the communication method and the item of the destination information in the transmission history record including the job ID and the user identification information included in the update instruction from among the transmission history records included in transmission history information 93A stored in HDD 107, with the communication method and the destination information included in the update instruction, respectively. In this manner, the communication method and the destination information are changed for the user who transmitted back in reply the data transmitted by first data transmission portion 81 or second data transmission portion 83.

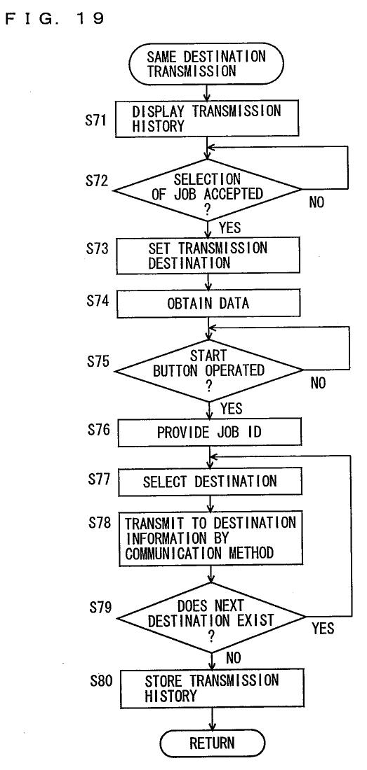

FIG. 18 is a flow chart showing an example of the flow of the main process according to the second embodiment. With reference to FIG. 18, the same process as that of the main process shown in FIG. 11 is denoted by the same reference characters. Here, mainly, the differences in the process will be described.

In step S03A, data is transmitted. Here, unlike MFP 100 in the first embodiment, the data is transmitted to the destination information by the communication method inputted into input portion 119A by the user. When the data is transmitted in step S03A, transmission history information is stored in HDD 107 in step S04A. Here, transmission history information 93A shown in FIG. 17 is stored in HDD 107.

When the data reply process is completed in step S06, it is determined whether a same destination transmission instruction is accepted or not in step S06A. If the same destination transmission instruction is accepted, the process moves on to step S06B, and if not, step S06B is skipped and the process moves on to step S07. The same destination transmission instruction is accepted when the user instructs on the button for instructing the same destination transmission provided in advance on input portion 119A.

In step S06B, the same destination transmission process is executed, and the process proceeds to step S07. FIG. 19 is a flow chart showing an example of the flow of the same destination transmission process. The same destination transmission process is a process executed in step S06B of FIG. 18.

With reference to FIG. 19, CPU 101 provided in MFP 100 that functions as the data transmission apparatus displays transmission history information 93A stored in HDD 107 on display portion 119B (step S71). When the user of the user identification information “David” logs in at MFP 100, the transmission history record having “David” set in the item of the transmission origin of transmission history information 93A shown in FIG. 17 is read and displayed on display portion 119B.

Thereafter, the process stands by until the selection of a job is accepted (NO in step S72), and when the selection of the job is accepted (YES in step S72), the process moves on to step S73. The selection of the job is accepted if an instruction is accepted that selects one job ID from the displayed transmission history record. Then, a set of the communication method and the destination information set in the item of communication method and the item of destination information in the transmission history record that includes the selected job ID is set as the transmission destination (step S73).

In step S74, the designation of the data to be transmitted is accepted, and the designated data is obtained. In the next step S75, the process stands by until a start button provided on input portion 119A is pressed (NO in step S75), and when the start button is pressed (YES in step S75), the process moves on to step S76.

In step S76, a job ID is given. Here, the job ID is “MFP-1-001,” which is a combination of the apparatus identification information “MFP-1” of MFP 100 and a serial number “001.”

Next, one of the sets of the communication method and the destination information set as a transmission destination in step S73 is selected as the object of processing (step S77). This is because, in some cases, a plurality of sets of the communication method and the destination information are set as the transmission destinations. The multiple sets set as the transmission destinations are set one by one as the object of processing.

In step S78, the job ID, the user identification information of the transmission origin, the user identification information of the transmission destination, and the data obtained in step S74 are transmitted to the destination information by the communication method included in the set which is the object of processing. Moreover, only the job ID and the data obtained in step S74 may be transmitted to the destination information by the communication method included in the set which is the object of processing. The job ID is the job ID given in step S76, the user identification information of the transmission origin is the user identification information of the user (log-in user) who instructed the transmission of the data, and the user identification information of the transmission destination is the user identification information set in the item of the transmission destination in the transmission history record selected in step S72.

In the next step S79, it is determined whether a set that has not yet been set as the object of processing exists among the sets of the destination information and the communication method set as the transmission destinations or not. If such a set exists, the process goes back to step S77, and if not, the process moves on to step S80. In this manner, step S78 is executed for every one of the multiple sets set as the transmission destinations so that, for all the sets set as the transmission destinations, the job ID and the data obtained in step S74 are transmitted to the destination information using the communication method included in each set.

In step S80, one transmission history record is generated every time data is transmitted, and is additionally stored in transmission history information 93A stored in HDD 107. The transmission history record includes the job ID given in step S76, the user identification information of the user who instructed the transmission of the data, namely, the log-in user here, the user identification information set in the item of the transmission destination of the transmission history record selected in step S72, and the time and date at which the data was transmitted.

Here, the user of the user identification information “David” has logged in at MFP 100 so that the transmission history record that has “David” set in the item of the transmission origin in transmission history information 93A shown in FIG. 17 is displayed on display portion 119B. When the user of the user identification information “David” selects the displayed transmission history record and instructs which data to be transmitted, the data is transmitted to each of the user identification information “Julie,” “Ted,” “Michael,” and “Susan” set in the item of the transmission destination of the selected transmission history record by the communication method set in the item of the communication method and to the destination information set in the item of the destination information.

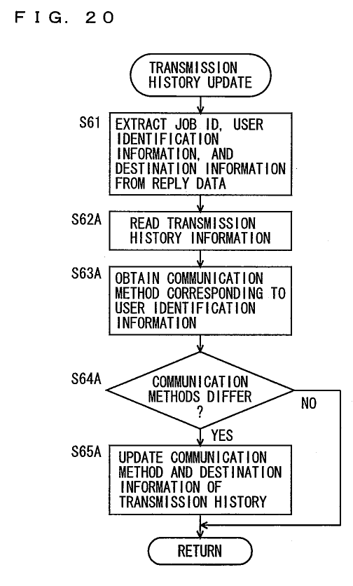

FIG. 20 is a flow chart showing an example of the flow of a transmission history update process. The transmission history update process is a process executed by CPU 101 provided in MFP 100 that functions as the data transmission apparatus in step S12A of FIG. 18. The same process as that of the user table update process shown in FIG. 14 is denoted by the same reference characters. While the object of the update is user table 91 in the user table update process shown in FIG. 14, the transmission history update process differs in that the object of the update is transmission history information 93A. Here, the points on which the transmission history update process differs from the user table update process will be described.

In addition, for illustration, the case where the user of the user identification information “Julie” logs in at MFP 100A that functions as the data reception apparatus and receives the reply data will be described as an example, as was done in relation to the data reply process shown in FIG. 13 in the first embodiment. In this case, “Julie” who is the log-in user selects the communication method “electronic mail” and inputs the destination information “julie@xxx.jp” so that MFP 100 that functions as the data transmission apparatus receives the electronic mail which includes the reply data including the job ID “MFP-1-001,” the user identification information “Julie,” and the destination information “julie@xxx.jp” and whose address of the destination is the electronic mail address “mfp-1-1@xxx.jp” assigned to MFP 100.

With reference to FIG. 20, CPU 101 provided in MFP 100 that functions as the data transmission apparatus extracts the job ID, the user identification information, and the destination information included in the reply data (step S61). Here, the job ID “MFP-1-001,” the user identification information “Julie,” and the destination information “julie@xxx.jp” are extracted from the reply data.

In the next step S62A, transmission history information 93A stored in HDD 107 is read. Then, the communication method set in transmission history information 93A as corresponding to the user identification information “Julie” is obtained (step S63A). More specifically, the communication method “FAX” which is set in the item of the communication method in the transmission history record that includes the job ID “MFP-1-001” and the user identification information “Julie” extracted in step S61 is obtained from the read transmission history information 93A.

Then, it is determined whether the communication method by which the reply data was received is different from the communication method obtained in step S63A or not (step S64A). If they are different, the process proceeds to step S65A, but if they are the same, the process goes back to the main process. The communication method by which the reply data was received is “electronic mail” and the communication method obtained in step S63A is “FAX.” Therefore, here, the process proceeds to step S65A.

In step S65A, the communication method and the destination information in transmission history information 93A are updated with the communication method by which the reply data was received and with the destination information extracted from the reply data in step S61. More specifically, the item of the communication method and the item of the destination information in the transmission history record that has the job ID “MFP-1-001” and the user identification information “Julie” that are extracted from the reply data in step S61 set in the item of the user identification information in transmission history information 93A stored in HDD 107 are updated with the communication method “electronic mail” by which the reply data was received and with the destination information “julie@xxx.jp” extracted from the reply data.

Due to the fact that MFP 100A that functions as the data reception apparatus receives the data transmitted by David from MFP 100 that functions as the data transmission apparatus, the user of the user identification information “Julie” obtains that data by the communication method “FAX.” Thereafter, if the user of the user identification information “Julie” wishes to receive the data not by the communication method of “FAX” but by the communication method of “electronic mail,” the user may have MFP 100A that functions as the data reception apparatus transmit by electronic mail the reply data for the data received by the communication method “FAX,” thereby causing transmission history information 93A stored in HDD 107 in MFP 100 that functions as the data transmission apparatus to be updated. Thus, the user receiving the data can easily alter the communication method for transmitting the data stored in transmission history information 93A by the simple operation of transmitting back the data in reply. Moreover, the receiver of the data himself can set the communication method by which the data is to be received.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data communication system in which a plurality of data communication apparatuses are connected in a manner enabling communication, each of said plurality of data communication apparatuses comprising:
a communication portion capable of communicating in multiple types of communication methods; and
a user storage portion for associating and storing user identification information of a user, a communication method, and destination information for each said user;
among said plurality of data communication apparatuses, a data transmission apparatus includes
a destination designation portion for accepting designation of user identification information stored in said user storage portion,
a data accepting portion for accepting data,
a data transmission portion for controlling said communication portion to transmit said data accepted, based on a communication method and destination information stored in association with said user identification information accepted,
a comparing portion for comparing the communication method stored in association with user identification information included in reply data with a communication method by which said communication portion receives said reply data when said communication portion receives said reply data for said data transmitted, and
an update portion for updating the communication method and the destination information stored in association with the user identification information included in said reply data with the communication method by which said communication portion received said reply data and with the destination information included in said reply data if the communication method stored in association with the user identification information included in said reply data and the communication method by which said communication portion received said reply data do not match as a result of a comparison by said comparing portion.

2. A data communication system according to claim 1, wherein, among said plurality of data communication apparatuses, a data reception apparatus for receiving data transmitted by said data transmission portion includes
an apparatus storage portion for storing in association destination information for each of said multiple types of communication methods assigned for each of other data communication apparatuses among said plurality of data communication apparatuses,
a reception history storage portion for storing, in response to said communication portion receiving said data, reception history which includes apparatus identification information for identifying an apparatus that transmitted said data,
an authentication portion for authenticating a user,
a selecting portion for accepting selection of one communication method from said multiple types of communication methods in response to one of said reception history being designated by the user authenticated by said authentication portion,
a replying portion for transmitting reply data that includes the user identification information of the authenticated user and the destination information of said authenticated user corresponding to the selected communication method, based on said selected communication method and on the destination information corresponding to said selected communication method and stored in association with said apparatus identification information included in said reception history designated.

3. A data communication system according to claim 2, wherein said data transmission portion transmits a job ID for identifying a job of transmitting the data along with said data accepted, said data transmission apparatus further including a transmission history storage portion for storing transmission history that includes the job ID transmitted by said data transmission portion, and wherein
said reception history storage portion of said data reception apparatus stores reception history that includes a job ID received along with said data received and apparatus identification information for identifying an apparatus that transmitted the data, and
said replying portion transmits reply data that includes a job ID included in said reception history designated,
said data transmission apparatus further including a reply data determination portion for determining the data received by said communication portion as said reply data when the data received by said communication portion includes a same job ID as said job ID included in said transmission history.

4. A data communication system according to claim 1, wherein said data transmission portion transmits destination information assigned to said data transmission apparatus for each of said multiple types of communication methods along with said data, and
among said plurality of data communication apparatuses, a data reception apparatus for receiving data transmitted by said data transmission portion includes
a reception history storage portion for storing, in response to said communication portion receiving said data, reception history which includes destination information assigned to said data transmission apparatus for each of said multiple types of communication methods and received along with the data,
an authentication portion for authenticating a user,
a selecting portion for accepting selection of one communication method from said multiple types of communication methods in response to one of said reception history being designated by the user authenticated by said authentication portion, and
a replying portion for transmitting reply data that includes the user identification information of the authenticated user and the destination information of said authenticated user corresponding to the selected communication method, based on said selected communication method and on the destination information corresponding to said selected communication method among destination information assigned to said data transmission apparatus for each of said multiple types of communication methods included in said reception history designated.

5. A data communication system according to claim 4, wherein said data transmission portion transmits a job ID for identifying a job of transmitting the data along with said data accepted, said data transmission apparatus further including a transmission history storage portion for storing transmission history that includes the job ID transmitted by said data transmission portion, and wherein
said reception history storage portion of said data reception apparatus stores reception history that includes a job ID received along with said data received and apparatus identification information for identifying an apparatus that transmitted the data, and
said replying portion transmits reply data that includes a job ID included in said reception history designated,
said data transmission apparatus further including a reply data determination portion for determining the data received by said communication portion as said reply data when the data received by said communication portion includes a same job ID as said job ID included in said transmission history.

6. A data communication system in which a plurality of data communication apparatuses are connected in a manner enabling communication, each of said plurality of data communication apparatuses comprising
a communication portion capable of communicating in multiple types of communication methods, and
among said plurality of data communication apparatuses, a data transmission apparatus includes
a destination designation portion for accepting destination information and a communication method of communicating data for a user at transmission destination,
a data accepting portion for accepting data,
a first data transmission portion for controlling said communication portion to transmit said data accepted and a job ID for identifying a job of transmitting the data, based on said communication method and the destination information accepted,
a transmission history storage portion for storing transmission history that includes destination information and a communication method of communicating data transmitted by said first data transmission portion, user identification information for identifying said user at the transmission destination, and said job ID,
a second data transmission portion for transmitting data based on said communication method and said destination information included in said transmission history when one of said transmission history is designated,
a comparing portion for comparing the communication method included in said transmission history including the job ID and the user identification information included in reply data with a communication method by which said communication portion receives said reply data when said communication portion receives said reply data for said data transmitted, and
an update portion for updating the communication method and the destination information included in said transmission history including the job ID and the user identification information included in said reply data with the communication method by which said communication portion received said reply data and with the destination information included in said reply data if the communication method included in said transmission history including the job ID and the user identification information included in said reply data and the communication method by which said communication portion received said reply data do not match as a result of a comparison by said comparing portion.

7. A data communication system according to claim 6, wherein said first data transmission portion transmits destination information assigned to said data transmission apparatus for each of said multiple types of communication methods along with said data, and
among said plurality of data communication apparatuses, a data reception apparatus for receiving data transmitted by said data transmission portion includes
a reception history storage portion for storing, in response to said communication portion receiving said data, reception history which includes destination information assigned to said data transmission apparatus for each of said multiple types of communication methods and received along with the data,
an authentication portion for authenticating a user,
a selecting portion for accepting selection of one communication method from said multiple types of communication methods in response to one of said reception history being designated by the user authenticated by said authentication portion, and
a replying portion for transmitting reply data that includes the user identification information of the authenticated user and the destination information of said authenticated user corresponding to the selected communication method, based on said selected communication method and on the destination information assigned to said selected communication method among destination information assigned to said data transmission apparatus for each of said multiple types of communication methods included in said reception history designated.

8. A data transmission apparatus, comprising:
a communication portion capable of communicating in multiple types of communication methods;
a user storage portion for associating and storing user identification information of a user, a communication method, and destination information for each said user;
a destination designation portion for accepting designation of user identification information stored in said user storage portion;
a data accepting portion for accepting data;
a data transmission portion for controlling said communication portion to transmit said data accepted, based on a communication method and destination information stored in association with said user identification information accepted;
a comparing portion for comparing the communication method stored in association with user identification information included in reply data with a communication method by which said communication portion receives said reply data when said communication portion receives said reply data for said data transmitted; and
an update portion for updating the communication method and the destination information stored in association with the user identification information included in said reply data with the communication method by which said communication portion received said reply data and with the destination information included in said reply data if the communication method stored in association with the user identification information included in said reply data and the communication method by which said communication portion received said reply data do not match as a result of a comparison by said comparing portion.

9. A data transmission apparatus, comprising:
a communication portion capable of communicating in multiple types of communication methods;
a destination designation portion for accepting destination information and a communication method of communicating data for a user at transmission destination;
a data accepting portion for accepting data;
a first data transmission portion for controlling said communication portion to transmit said data accepted and a job ID for identifying a job of transmitting the data, based on said communication method and the destination information accepted;
a transmission history storage portion for storing transmission history that includes destination information and a communication method of communicating data transmitted by said first data transmission portion, user identification information for identifying said user at the transmission destination, and said job ID;
a second data transmission portion for transmitting data based on said communication method and said destination information included in said transmission history when one of said transmission history is designated;
a comparing portion for comparing the communication method included in said transmission history including the job ID and the user identification information included in reply data with a communication method by which said communication portion receives said reply data when said communication portion receives said reply data for said data transmitted; and
an update portion for updating the communication method and the destination information included in said transmission history including the job ID and the user identification information included in said reply data with the communication method by which said communication portion received said reply data and with the destination information included in said reply data if the communication method included in said transmission history including the job ID and the user identification information included in said reply data and the communication method by which said communication portion received said reply data do not match as a result of a comparison by said comparing portion.

10. A transmission destination update method executed by a data transmission apparatus including a communication portion capable of communicating in multiple types of communication methods, and a user storage portion for associating and storing user identification information of a user, a communication method, and destination information for each said user, the method comprising the steps of:
accepting designation of user identification information stored in said user storage portion;
accepting data;
controlling said communication portion to transmit said data accepted, based on a communication method and destination information stored in association with said user identification information accepted;
comparing the communication method stored in association with user identification information included in reply data with a communication method by which said communication portion receives said reply data when said communication portion receives said reply data for said data transmitted; and
updating the communication method and the destination information stored in association with the user identification information included in said reply data with the communication method by which said communication portion received said reply data and with the destination information included in said reply data if the communication method stored in association with the user identification information included in said reply data and the communication method by which said communication portion received said reply data do not match as a result of said comparison.

11. A transmission destination update method executed by a data transmission apparatus including a communication portion capable of communicating in multiple types of communication methods, comprising the steps of:
accepting destination information and a communication method of communicating data for a user at transmission destination;
accepting data;
controlling said communication portion to transmit said data accepted and a job ID for identifying a job of transmitting the data, based on said communication method and the destination information accepted;
storing transmission history that includes a communication method and destination information of said data transmitted, user identification information for identifying said user at the transmission destination, and said job ID;
transmitting data based on said communication method and said destination information included in said transmission history when one of said transmission history is designated;
comparing the communication method included in said transmission history including the job ID and the user identification information included in reply data with a communication method by which said communication portion receives said reply data when said communication portion receives said reply data for said data transmitted; and
updating the communication method and the destination information included in said transmission history including the job ID and the user identification information included in said reply data with the communication method by which said communication portion received said reply data and with the destination information included in said reply data if the communication method included in said transmission history including the job ID and the user identification information included in said reply data and the communication method by which said communication portion received said reply data do not match as a result of said comparison.

12. A transmission destination update program embodied on a computer readable medium causing a computer controlling a data transmission apparatus including a communication portion capable of communicating in multiple types of communication methods, and a user storage portion for associating and storing user identification information of a user, a communication method, and destination information for each said user, to execute the following steps of:
accepting designation of user identification information stored in said user storage portion;
accepting data;
controlling said communication portion to transmit said data accepted based on a communication method and destination information stored in association with said user identification information accepted;
comparing the communication method stored in association with user identification information included in reply data with a communication method by which said communication portion receives said reply data when said communication portion receives said reply data for said data transmitted; and
updating the communication method and the destination information stored in association with the user identification information included in said reply data with the communication method by which said communication portion received said reply data and with the destination information included in said reply data if the communication method stored in association with the user identification information included in said reply data and the communication method by which said communication portion received said reply data do not match as a result of said comparison.

13. A transmission destination update program embodied on a computer readable medium causing a computer controlling a data transmission apparatus including a communication portion capable of communicating in multiple types of communication methods to execute the following steps of:
accepting destination information and a communication method of communicating data for a user at transmission destination;
accepting data;
controlling said communication portion to transmit said data accepted and a job ID for identifying a job of transmitting the data, based on said communication method and the destination information accepted;
storing transmission history that includes destination information and a communication method of said data transmitted, user identification information for identifying said user at the transmission destination, and said job ID;
transmitting data based on said communication method and said destination information included in said transmission history when one of said transmission history is designated;
comparing the communication method included in said transmission history including the job ID and the user identification information included in reply data with a communication method by which said communication portion receives said reply data when said communication portion receives said reply data for said data transmitted; and
updating the communication method and the destination information included in said transmission history including the job ID and the user identification information included in said reply data with the communication method by which said communication portion received said reply data and with the destination information included in said reply data if the communication method included in said transmission history including the job ID and the user identification information included in said reply data and the communication method by which said communication portion received said reply data do not match as a result of said comparison.
